(19) United States
(12) Patent Application Publication
(10) Pub. No.: US 2015/0023666 A1
(43) Pub. Date: Jan. 22, 2015

(54) NETWORK DESIGNING APPARATUS, NETWORK DESIGNING METHOD, AND NETWORK DESIGNING PROGRAM

(71) Applicant: FUJITSU LIMITED, Kawasaki-shi (JP)

(72) Inventors: Tomohiro Hashiguchi, Inagi (JP); Kazuyuki Tajima, Yokosuka (JP); Yutaka Takita, Kawasaki (JP)

(21) Appl. No.: 14/322,137

(22) Filed: Jul. 2, 2014

(30) Foreign Application Priority Data
Jul. 18, 2013 (JP) 2013-149840

(51) Int. Cl. H04L 12/24; H04B 10/27; H04J 14/02

(52) U.S. Cl. CPC H04L 41/12; H04J 14/0267; H04B 10/27
USPC 398/79

(57) ABSTRACT

A network designing apparatus which includes a first processing unit configured to select one or more paths formed among nodes in a network according to demands of bandwidths, determine a plurality of working communication routes and a plurality of protecting communication routes that connect the nodes to each other, respectively and estimate bandwidths and the number of communication lines required in one or more selected paths, respectively; and a second processing unit configured to allocate a predetermined number of logical channels to the working communication routes and the protecting communication routes based on the demanded bandwidths, the predetermined number of logical channels being corresponding to a number of logical channels that each of the communication lines has. The first processing unit is configured to permit the one or more paths to be shared among the plurality of protecting communication routes to determine the protecting communication routes and estimate bandwidths shared among communication routes sharing the paths.

### CROSS-REFERENCE TO RELATED APPLICATION

This application is based upon and claims the benefit of priority from the prior Japanese Patent Application No. 2013-149840 filed on Jul. 18, 2013, the entire contents of which are incorporated herein by reference.

### FIELD

Embodiments of the present disclosure relate to a network designing apparatus, a network designing method, and a network designing program.

### BACKGROUND

With an increase of communication demand, a high-speed optical transportation scheme is standardized. For example, G.709 recommended by the International Telecommunication Union Telecommunication Standardization Sector (ITU-T) prescribes a technology of an optical transport network (OTN) of approximately 2.5 Gbps to 100 Gbps.

Optical transportation by the OTN is performed by multiplexing a plurality of optical signals that accommodate user signals, respectively by using, for example, wavelength division multiplexing (WDM) technology to enable a mass data transmission. The user signals received in the optical signals may include a synchronous digital hierarchy (SDH) frame, a synchronous optical network (SONET) frame, and an Ethernet (registered mark, hereinafter, the same is applied) frame.

Meanwhile, in the Internet Engineering Task Force (IETF), it is reviewed that a signaling technology of generalized multi-protocol label switching (GMPLS) is extended to apply the GMPLS to the OTN. As a fault recovery means of the OTN using the GMPLS, a “shared mesh restoration” scheme (hereinafter, referred to as an SMR scheme) may be used.

According to the SMR scheme, network resources can be shared between protecting traffics for protecting an working traffic in which the network resources (that is, a transmission path or a transmission apparatus) are not shared and a fault does not occur by the same cause with respect to the working traffic. As a result, an economical network is demanded to be constructed by using a design technique of an SMR scheme network.

For example, Japanese Patent Application Laid-Open No. 1992-263540 discloses that a predetermined number of lines are allocated to a protecting link in advance and some of the allocated lines are deleted to satisfy a fault recovery rate, in regard to network design. Further, Japanese Patent Application Laid-Open No. 2003-115872 discloses a technique that implements a bandwidth sharing of a protecting path.

See, for example, Japanese Patent Application Laid-Open No. 1992-263540 and Japanese Patent Application Laid-Open No. 2003-115872.

When the SMR scheme is adopted, a technique that dynamically allocates the network resource to the protecting traffic and a technique that fixedly allocates the network resource in advance are provided. In the former, since a complicated control needs to be performed at the time of switching a route from the working system to the protecting system, it takes a longer time than the latter. As a result, from the viewpoint of rapid fault recovery, the latter is more preferable than the former.

The fixed allocation of the network resource is performed by allocation of respective logical channels included in, for example, a protecting optical signal from the viewpoint of an efficient operation of the network resource. For example, in the case of the OTN, a higher order optical channel data unit (HO-ODU) which is a data format of the optical single has a field corresponding to a logical channel called “tributary slot (TS)”. A lower order (LO)-ODU that accommodates a user signal is accommodated in the TS.

Therefore, in the OTN, in order to perform the network design for implementing the SMR scheme, the TS is individually allocated to the protecting traffic. In this case, further, it is preferable that the number of communication lines of which routes can be switched when a plurality of faults occurs is increased by forming restriction condition in the number and types (bandwidths) of the protecting traffics that share the TS to improve the recovery performance of the network.

However, it is difficult to complete a network design that considers both the HO-ODU (optical signal) and the TS (logical channel) within an actual time because the problem to be analyzed is large in scale and complicate. Further, the problem is not limited to the OTN and exists similarly even in designing other networks.

Therefore, the present disclosure is conceived to solve the problem and an object of the present disclosure is to provide a network designing apparatus, a network designing method, and a network designing program that can shorten a design time.

### SUMMARY

According to one aspect of the present disclosure, there is provided a network designing apparatus which includes: a first processing unit configured to select one or more paths formed among nodes in a network according to demands of bandwidths, each of which is used in communication among a plurality of sets of nodes in the network, determine a plurality of working communication routes and a plurality of protecting communication routes that connect the plurality of sets of nodes to each other, respectively and estimate bandwidths and the number of communication lines required in one or more selected paths, respectively; and a second processing unit configured to allocate a predetermined number of logical channels to the plurality of working communication routes and the plurality of protecting communication routes based on the demanded bandwidths, predetermined number of logical channels being corresponding to a bandwidth that each of the communication lines has. In the network designing apparatus, the first processing unit permits the one or more paths to be shared among the plurality of protecting communication routes to determine the plurality of protecting communication routes and estimate the bandwidths of the communication lines so that a ratio of a total bandwidth demanded for the plurality of communication routes sharing the path among the plurality of protecting communication routes to the bandwidth shared among the plurality of communication routes is equal to or less than a predetermined number. In the network designing apparatus, the second processing unit allocates the common logical channel to the number of communication routes having the predetermined number or less, which share the one or more paths and are not simultaneously used when a fault occurs in the plurality of working communication routes, among the plurality of protecting communication routes.

According to another aspect of the present disclosure, there is provided a network designing apparatus which includes: a first processing unit configured to select one or more paths formed among nodes in a network according to demands of bandwidths, each of which is used in communication among a plurality of sets of nodes in the network, determine a plurality of working communication routes and a plurality of protecting communication routes that connect the plurality of sets of nodes to each other, respectively and estimate bandwidths and the number of communication lines required in one or more selected paths, respectively; and a second processing unit configured to allocate a predetermined number of logical channels to the plurality of working communication routes and the plurality of protecting communication routes based on the demanded bandwidths, the predetermined number of logical channels being corresponding to a number of logical channels that each of the communication lines has. In the network designing apparatus, the first processing unit is configured to permit the one or more paths to be shared among the plurality of protecting communication routes to determine the plurality of protecting communication routes and estimate bandwidths shared among communication routes sharing the one or more paths among the plurality of protecting communication routes, for each type of the demanded bandwidths. In the network designing apparatus, the second processing unit allocates a common logical channel to the communication routes which have the same types of the demanded bandwidths, share one or more paths and are not simultaneously used when the fault occurs in the working communication routes, among the plurality of protecting communication routes.

According to yet another aspect of the present disclosure, there is provided a network designing method which includes: selecting one or more paths formed among nodes in a network according to demands of bandwidths, each of which is used in communication among a plurality of sets of nodes in the network, to determine a plurality of working communication routes and a plurality of protecting communication routes that connect the plurality of sets of nodes to each other, respectively, and estimating bandwidths and the number of communication lines required in each of the one or more selected paths; and allocating a predetermined number of logical channels to the plurality of working communication routes and the plurality of protecting communication routes based on the demanded bandwidths, the predetermined number of logical channels being corresponding to a number of logical channels that each of the communication lines has. In the estimating bandwidths and the number of communication lines, the one or more paths is permitted to be shared among the plurality of protecting communication routes to determine the plurality of protecting communication routes and estimate the bandwidths of the communication lines so that a ratio of a total bandwidth demanded for the plurality of communication routes sharing the path among the plurality of protecting communication routes to the bandwidth shared among the plurality of communication routes is equal to or less than a predetermined number. In the allocating a predetermined number of logical channel, the common logical channel is allocated to the number of communication routes having the predetermined number or less, which share the one or more paths and are not simultaneously used when a fault occurs in the plurality of working communication routes, among the plurality of protecting communication routes.

According to yet another aspect of the present disclosure, there is provided a computer-readable recording medium storing a network designing program, when executed, causes a computer to perform a network designing method which includes: selecting one or more paths formed among nodes in a network according to demands of bandwidths, each of which is used in communication among a plurality of sets of nodes in the network, to determine a plurality of working communication routes and a plurality of protecting communication routes that connect the plurality of sets of nodes to each other, respectively, and estimating bandwidths and the number of communication lines required in each of the one or more selected paths; and allocating a predetermined number of logical channels to the plurality of working communication routes and the plurality of protecting communication routes based on the demanded bandwidths, the predetermined number of logical channels being corresponding to a number of logical channels that each of the communication lines has. In the estimating bandwidths and the number of communication lines, the one or more paths is permitted to be shared among the plurality of protecting communication routes to determine the plurality of protecting communication routes and estimate the bandwidths of the communication lines so that a ratio of a total bandwidth demanded for the plurality of communication routes sharing the path among the plurality of protecting communication routes to the bandwidth shared among the plurality of communication routes is equal to or less than a predetermined number. In the allocating a predetermined number of logical channel, the common logical channel is allocated to the number of communication routes having the predetermined number or less, which share the one or more paths and are not simultaneously used when a fault occurs in the plurality of working communication routes, among the plurality of protecting communication routes.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an example of a network.

FIG. 2 is a configuration diagram illustrating a configuration example of an optical signal.

FIG. 3 is a diagram illustrating a state in which a TS of an HO-ODU is allocated to a demanded traffic (when Condition (1) and Condition (2) are disregarded).

FIG. 4 is a diagram illustrating a state in which the TS of the HO-ODU is allocated to the demanded traffic (when Condition (1) is satisfied).

FIG. 5 is a diagram illustrating a state in which the TS of the HO-ODU is allocated to the demanded traffic (when Condition (2) is satisfied).

FIG. 6 is a diagram illustrating a state in which the TS of the HO-ODU is allocated to the demanded traffic (when Condition (1) and Condition (2) are satisfied).

FIG. 7 is a configuration diagram illustrating an example of a network designing apparatus according to an embodiment.

FIG. 8 is a configuration diagram illustrating a functional configuration of a central processing unit (CPU) and an example of information conserved by a hard disk drive (HDD).

FIG. 9 is a flowchart illustrating a process performed by the CPU.

FIG. 10 is a flowchart illustrating first design processing executed by a first processing unit.

FIG. 11 is a diagram illustrating an example of paths formed in a network.

FIG. 12 is a diagram illustrating a candidate of a communication route constituted by the path illustrated in FIG. 11.

FIG. 13 is a diagram illustrating an example of the HO-ODU required in the path.

FIGS. 14A and 14B illustrate an example of allocation of a sharing bandwidth of the HO-ODU for the demanded traffic.

FIG. 15 illustrates an example of estimating the sharing bandwidth for each type of the bandwidth of the demanded traffic.

FIG. 16 is a table illustrating a content of a set used in a model of an integer programming problem constructed by the first processing unit.

FIG. 17 is a table illustrating a content of a variable used in the model of the integer programming problem constructed by the first processing unit.

FIG. 18 is a table illustrating a content of a parameter used in the model of the integer programming problem constructed by the first processing unit.

FIG. 19 is a diagram illustrating an example of the allocation of the TS of the HO-ODU illustrated in FIG. 13.

FIG. 20 is a flowchart illustrating second design processing executed by a second processing unit.

FIG. 21 is a diagram illustrating an example of a working communication route and a protecting communication route in the network.

FIG. 22 is a table illustrating a comparative example of allocation of the TS to the protecting communication route illustrated in FIG. 21.

FIG. 23 is a table illustrating the working communication route in which the fault occurs by a link failure in the network illustrated in FIG. 21.

FIG. 24 is a table illustrating an example of the allocation of the TS to the protecting communication route illustrated in FIG. 21.

FIG. 25 is a table illustrating a content of a set used in a model of an integer programming problem constructed by the second processing unit.

FIG. 26 is a table illustrating a content of a variable used in the model of the integer programming problem constructed by the second processing unit.

FIG. 27 is a table illustrating a content of a parameter used in the model of the integer programming problem constructed by the second processing unit.

FIGS. 28A and 28B are diagrams illustrating examples of results of first design processing and second design processing in a comparative example.

FIGS. 29A and 29B are diagrams illustrating examples of results of first design processing and second design processing in an embodiment.

FIG. 30 is a diagram illustrating an example of a demand imparted to a network.

FIG. 31 is a diagram illustrating working and protecting communication routes of the network illustrated in FIG. 30.

FIG. 32 is a table illustrating the working communication route in which the fault occurs by a link failure illustrated in FIG. 31.

FIG. 33 is a table illustrating an example of the allocation of the TS to the protecting communication route illustrated in FIG. 31.

FIG. 34 is a diagram illustrating another example of the demand imparted to the network.

FIG. 35 is a diagram illustrating working and protecting communication routes of the network illustrated in FIG. 34.

FIG. 36 is a table illustrating the working communication route in which the fault occurs by a link failure illustrated in FIG. 35.

FIG. 37 is a table illustrating an example of allocation of a TS to the protecting communication route illustrated in FIG. 35.

### DESCRIPTION OF EMBODIMENTS

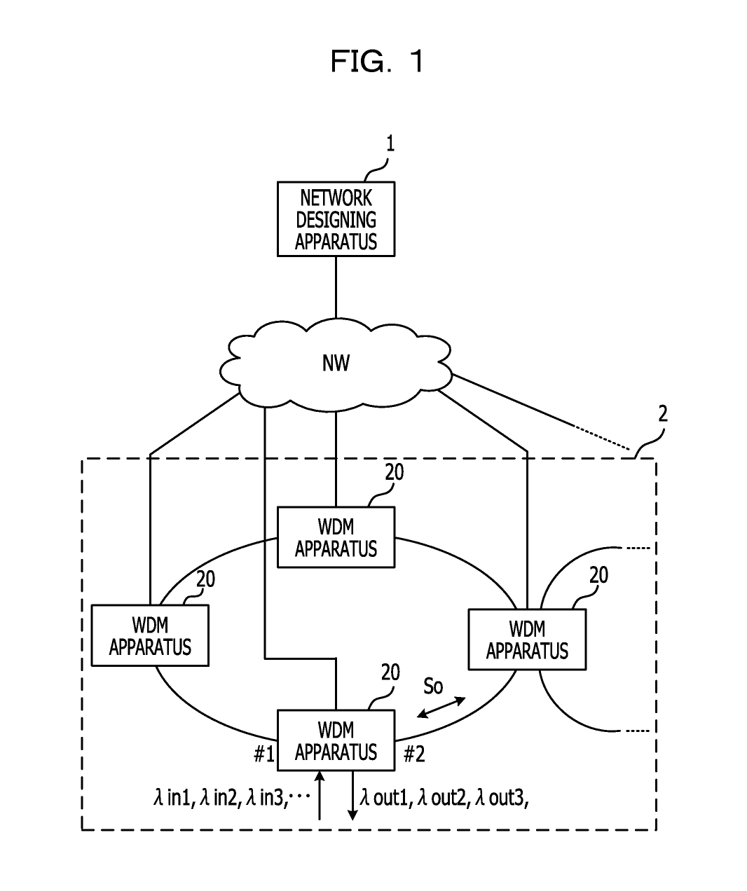

FIG. 1 is a configuration diagram illustrating one example of a network. A network designing apparatus 1 is connected with a plurality of WDM apparatuses 20 through a monitoring control network NW such as, for example, a local area network (LAN). The network designing apparatus 1 may be used as a network management system (NMS).

The WDM apparatus 20 is, for example, a light branching and inserting apparatus called a reconfigurable optical add-drop multiplexer (ROADM). The respective WDM apparatuses 20 are connected to each other by an optical fiber, and for example, constitute a ring-shaped network 2. Further, a network 2 is not limited to a form illustrated in FIG. 1 and, for example, may have a mesh type form. The network designing apparatus 1 designs the network 2 formed of the WDM apparatuses 20.

Optical signals having predetermined wavelengths λin1, λin2, λin3 are input into the respective WDM apparatuses 20 and each WDM apparatus 20 wavelength-multiplexes the optical signal and transmits the wavelength-multiplexed optical signal to other WDM apparatuses 20 as a wavelength-multiplexed optical signal So. Further, each WDM apparatus 20 separates and outputs the optical signals having the predetermined wavelengths λout1, λout2, λout3, etc. from the wavelength-multiplexed optical signal So transmitted from other WDM apparatuses 20. Further, in the following description, inputting the optical signals λin1, λin2, λin3, etc. into the WDM apparatus 20 from the outside is referred to as “inserting” and outputting the optical signals λout1, λout2, λout3, etc. into the outside from the WDM apparatus 20 is referred to as “branching”.

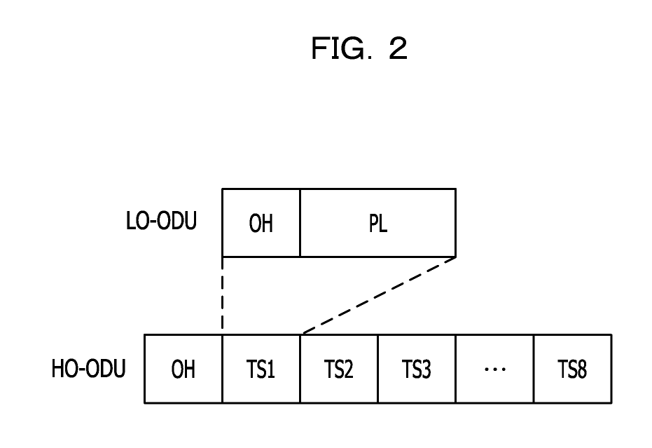

FIG. 2 is a configuration diagram illustrating a configuration example of an optical signal. The optical signal has a configuration of an HO-ODU prescribed in G.709 recommended by the ITU-T as one example. The HO-ODU has an overhead OH including predetermined control information and TS1 to TS8 which are logical channels (hereinafter, referred to as “TS”).

A plurality of types of transmission speed of the HO-ODU is present. G.709 recommended by the ITU-T prescribes “ODU0” of 1.25 Gbps, “ODU1” of 2.5 Gbps, “ODU2” of 10 Gbps, “ODU3” of 40 Gbps, and “ODU4” of 100 Gbps, etc.

The HO-ODU has the number of TSs depending on a transmission speed thereof, that is, the bandwidth. For example, the number of TSs is 8 when the bandwidth is “ODU2” and the number of TSs is 2 when the bandwidth is “ODU1”. Further, each of the bandwidths of TS1 to TS8 is 1.25 Gbps (that is, the bandwidth of ODU0). Further, a type of “ODU(n)” (n is a natural number) is referred to as “type of bandwidth” in the following description.

Each of TS1 to TS8 receives an LO-ODU. The LO-ODU has an overhead including predetermined control information and a payload PL. The payload PL receives user signals such as an SDH frame, an SONET frame, and an Ethernet frame. Accordingly, the HO-ODU multiplexes a plurality of LO-ODUs to receive a plurality of user signals. Further, in the specification, as the transportation scheme of the optical signal, the OTN prescribed in the G.709 recommended by the ITU-T is exemplified, but the transportation scheme is not limited thereto.

The network designing apparatus 1 opens communication lines for transmitting and receiving the HO-ODU to and from a plurality of paths formed in the network 2 according to a traffic demand of communication between nodes of the network 2, and allocates the TS to every traffic in demand. As a result, the optical signal is transmitted between the WDM apparatuses 20 so as to satisfy the traffic demand.

In the following description, a communication path in which an optical signal having a predetermined wavelength is inserted into the WDM apparatus 20 and thereafter, transmitted until being branched from other WDM apparatuses 20 is referred to as “path”. Further, the communication line for transmitting and receiving the HO-ODU is simply referred to as “HO-ODU”. Since the HO-ODU has a pair of transmitter and receiver for transmitting and receiving the optical signal, the HO-ODU influences the cost of network.

Since the network designing apparatus 1 permits sharing the protecting network resource based on the SMR scheme, a TS of an HO-ODU required in the protecting path is allocated to a plurality of demanded traffics. In this case, the TS is allocated so as to satisfy at least one of Conditions (1) and (2) described below.

Condition (1): The number of traffics in which the respective TS may be shared is set as a predetermined maximum number Nₘₐₓ or less.

Condition (2): The number of types of bandwidths of the traffics in which the respective TSs may be shared is only one.

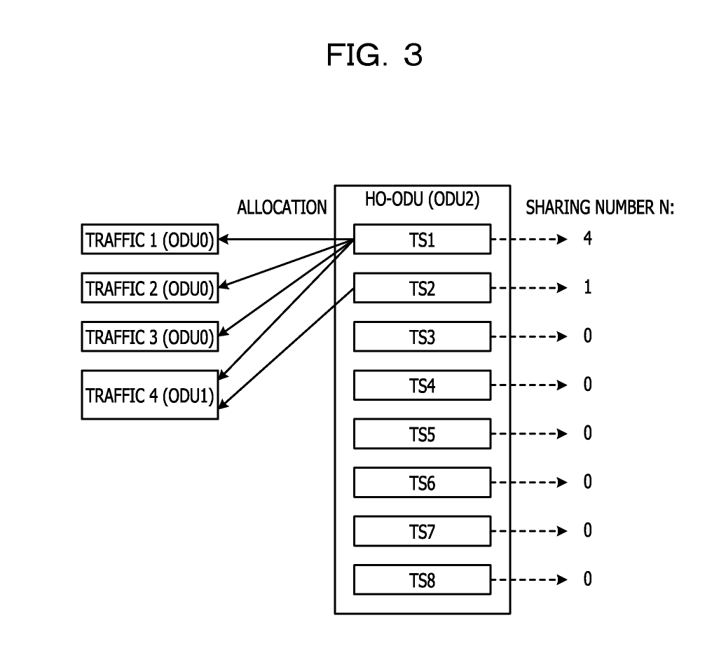

The number of communication lines capable of switching the paths when a plurality of faults occurs is increased by the network design that satisfies at least one of Conditions (1) and (2) to improve the recovery performance of the network 2. Hereinafter, the contents of Conditions (1) and (2) will be described in more detail with reference to FIGS. 3 to 6.

FIGS. 3 to 6 illustrate a state in which TS1 to TS8 of the HO-ODU are allocated to demanded traffics 1 to 4. In FIGS. 3 to 6, a description in parenthesis represents the bandwidth. That is, the bandwidths of the traffics 1 to 3 are ODU0 and the bandwidth of the traffic 4 is ODU1. As described above, since the bandwidth of the TS is ODU0, one TS is allocated to the traffics 1 to 3 and two TSs are allocated to the traffic 4. That is, the number of TSs is allocated to the traffics 1 to 4 depending on the type of bandwidth. Further, since the bandwidth of the HO-ODU is the ODU2, eight TSs, TS1 to TS8, are present in the HO-ODU.

In FIGS. 3 to 6, a “sharing number N” represents the number of the traffics 1 to 4 that share one TS. For example, when the TS1 is allocated to the traffics 1 to 3, the sharing number N of the TS1 is 3 and when the TS1 is allocated to only the traffic 1, that is, when the TS1 is not shared, the sharing number N of the TS1 is 1. Further, when the TS1 is not allocated to any one of the traffics 1 to 4, the sharing number N of the TS1 is 0.

FIG. 3 exemplifies a case of disregarding Conditions (1) and (2) and minimizing the number of TSs allocated to the traffics 1 to 4, as a comparative example. In this case, the TS1 is allocated to the traffics 1 to 4 and the TS2 is allocated to the traffic 4. As a result, the sharing number N of the TS1 is 4, the sharing number of the TS2 is 1, and the sharing number N of the other traffics, TS3 to TS8, is 0. Therefore, a total number of TSs allocated to the traffics 1 to 4 becomes 2.

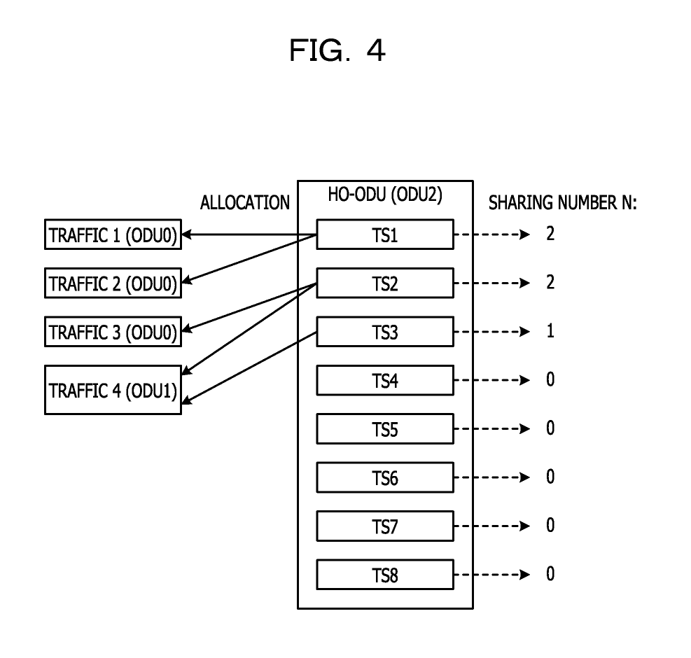

FIG. 4 exemplifies a case in which the sharing number N of the traffic is limited to a maximum number Nₘₐₓ (=2) or less so as to satisfy only Condition (1). In this case, the TS1 is allocated to the traffics 1 and 2, and the TS2 is allocated to the traffics 3 and 4. Further, the TS3 is allocated to the traffic 4.

As a result, each of the sharing numbers N of the TS1 and the TS2 is 2 and the sharing number of the TS3 is 1. Accordingly, since any sharing number N is the maximum number Nₘₐₓ or less, Condition (1) is satisfied. Further, the sharing number N of the other traffics, TS4 to TS8, is 0. Therefore, a total number of TSs allocated to the traffics 1 to 4 becomes 3.

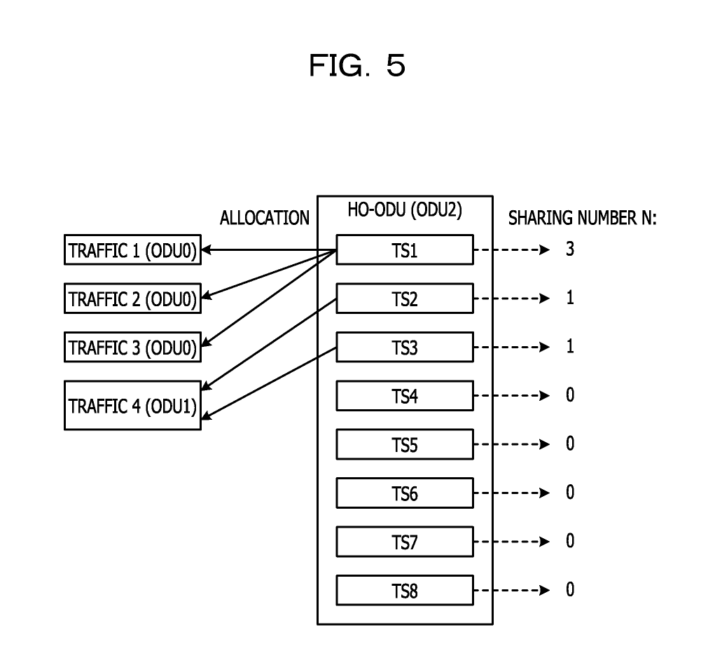

FIG. 5 exemplifies a case in which a type of bandwidth of a traffic to which each TS is allocated is limited to one type so as to satisfy only Condition (2). In this case, the TS1 is allocated to the traffics 1 to 3 and each of the TS2 and TS3 is allocated to the traffic 4. As a result, since the type (ODU0) of bandwidth of the traffics 1 to 3 to which the TS1 is allocated is the same and each of the TS2 and the TS3 is allocated to only the traffic 4, Condition (2) is satisfied.

The sharing number N of the TS1 is 3, each of the sharing numbers N of the TS2 and TS3 is 1, and the sharing number N of the other traffics, TS4 to TS8, is 0. Therefore, a total number of TSs allocated to the traffics 1 to 4 becomes 3.

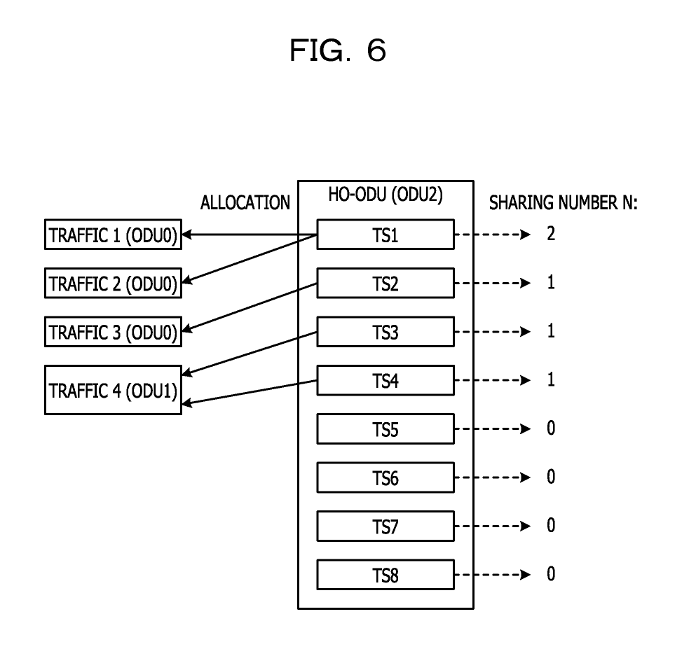

FIG. 6 exemplifies a case in which the sharing number N of each of the TS1 to TS8 is limited to the maximum number Nₘₐₓ (=2) or less and the type of bandwidth of the traffic to which each of the TS1 to TS8 is allocated is limited to one type, so as to satisfy Conditions (1) and (2). In this case, the TS1 is allocated to the traffics 1 to 2 and the TS2 is allocated to the traffic 3. Further, each of the TS3 and the TS4 is allocated to the traffic 4.

As a result, the sharing number N of the TS1 is 2 and the sharing number N of the TS2 to TS4 is 1. Accordingly, since any sharing number N is the maximum number Nₘₐₓ or less, Condition (1) is satisfied. Further, in the traffics 1 to 2 to which the TS1 is allocated, since the type (ODU0) of bandwidth is the same and each of the TS2 to TS4 is allocated to only one traffic 3 or 4, Condition (2) is satisfied.

The sharing number N of the other traffics, TS4 to TS8, is 0. Accordingly, the number of allocated TSs becomes 4.

As described above, when the network is designed under Conditions (1) and (2) as limitations (see, for example, FIGS. 4 to 6), the number of demanded TSs is larger than that in a case in which the network is designed without the limitations (see, for example, FIG. 3). However, since the aforementioned advantage is acquired in return for the increase in the number of TSs, the network designing apparatus 1 performs economical network design while satisfying at least one of Conditions (1) and (2) as described below.

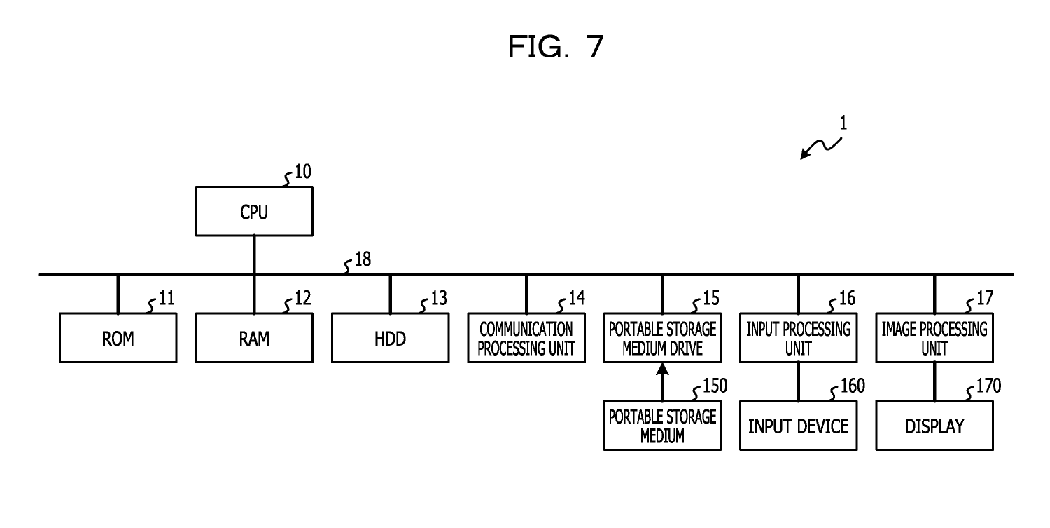

FIG. 7 illustrates a constitution of the network designing apparatus 1. The network designing apparatus 1 is, for example, a computer apparatus such as, for example, a server. The network designing apparatus 1 includes, for example, a CPU 10, a read only memory (ROM) 11, a random access memory (RAM) 12, an HDD 13, a communication processing unit 14, a portable storage medium drive 15, an input processing unit 16, and an image processing unit 17.

The CPU 10 is an operation processing device and performs designing of the network 2 according to a network designing program. The CPU 10 is connected to the respective units 11 to 17 through a bus 18 to communicate with the respective units 11 to 17. Further, the network designing apparatus 1 is not limited to being operated by software, and hardware such as, for example, an integrated circuit may be used for a specific purpose, instead of the CPU 10.

The RAM 12 is used as a working memory of the CPU 10. In addition, the ROM 11 and the HDD 13 may be used as a storage means that stores the network designing program that operates the CPU 10. The communication processing unit 14 is a communication means such as a network card that communicates with an external apparatus through the network such as a LAN. In the case of the constitution example illustrated in FIG. 1, the communication processing unit 14 communicates with a plurality of WDM apparatuses 20 through a monitoring control network NW.

The portable storage medium drive 15 is a device that records or reads information in or from a portable storage medium 150. Examples of the portable storage medium 150 may include a universal serial bus (USB) memory, a compact disc recordable (CD-R), and a memory card.

The network designing apparatus 1 further includes an input device 160 for performing an input operation of information and a display 170 for displaying an image. The input device 160 is an input mean such as a keyboard and a mouse and the input information is output to the CPU 10 through the input processing unit 16. The display 170 is a display means that displays an image, such as a liquid crystal display and displayed image data is output to the display from the CPU 10 through the image processing unit 17. Further, instead of the input device 160 and the display 170, a device such as a touch panel having functions thereof may be used.

The CPU 10 executes a program stored in the ROM 11 or the HDD 13 or a program which the portable storage medium drive 15 reads from the portable storage medium 150. The program includes an operating system (OS) and the network designing program. Further, the program may be downloaded through the communication processing unit 14.

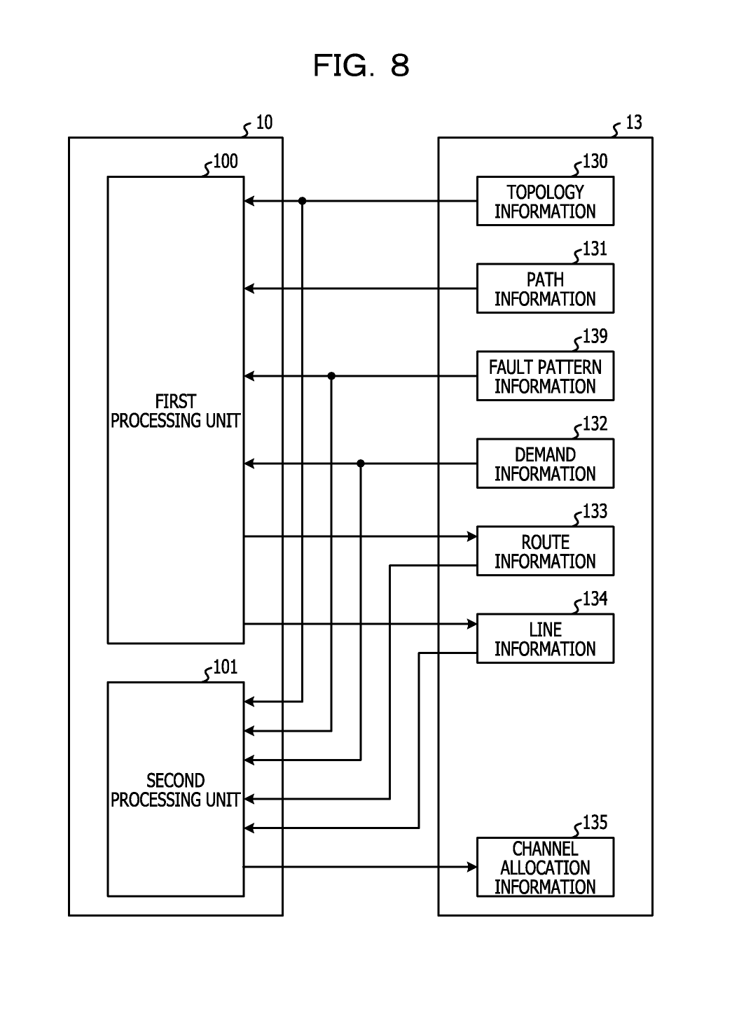

When the CPU 10 executes the network designing program, a plurality of functions is formed. FIG. 8 is a configuration diagram illustrating one example of a functional configuration of the CPU 10 and information conserved by the HDD 13.

The CPU 10 includes a first processing unit 100 and a second processing unit 101. Further, in association with the first processing unit 100 and the second processing unit 101, the HDD 13 conserves topology information 130, path information 131, fault pattern information 139, demand information 132, route information 133, line information 134, and channel allocation information 135. Further, a storage module of each information 130 to 135 is not limited to the HDD 13 and may be the ROM 11 or the portable storage medium 150.

The topology information 130 is information that represents a form of the network 2 to be designed, that is, a connection relationship between nodes through a link. The topology information 130 is configured such that, for example, identifiers of a pair of nodes connected through the link correspond to an identifier of each link in the network 2.

The path information 131 is information that represents a plurality of paths set in the network 2. The path information 131 includes, for example, identifiers of a plurality of sets of nodes that represents both nodes of the plurality of paths and identifiers of one or more links that connect both nodes to each other.

The fault pattern information 139 is information that represents occurrence patterns of various faults conceivable in the network 2 represented by the topology information 130. The faults include a single link failure or a plurality of link failures or a single node failure or a plurality of node failures.

The demand information 132 is information that represents a demand of a plurality of traffics to the network 2. The demand information 132 represents bandwidths used in respective communications among the plurality of sets of nodes in the network in regard to the individual demanded traffics. Further, the demand information 132 also includes sharing availability information that represents whether sharing the path in the network 2 is permitted, between different traffics. Further, the demand of the individual traffics is referred to as “demand” in the following description. Further, the topology information 130, the path information 131, and the demand information 132 may be acquired from the outside through, for example, the monitoring control network NW, the portable storage medium 150, or the input device 160.

The first processing unit 100 reads from the HDD 13 the topology information 130, the path information 131, the fault pattern information 139, and the demand information 132 and determines an working communication route and a protecting communication route according to the demand of the plurality of traffics, based on each information 130 to 132. The working communication route and the protecting communication route correspond to each other in a relationship of 1 to 1, and when the fault occurs in the working communication route, the traffic is switched to flow on the protecting communication route instead of the working communication route, by a protection function of the network 2.

The first processing unit 100 estimates bandwidths and the number of HO-ODUs required on one or more paths included in the determined working communication route and protecting communication route. The first processing unit 100 generates the route information 133 that represents the determined working communication route and protecting communication route and the line information 134 that represents the bandwidths and the number of HO-ODUs estimated for each path as a design result, and records the information in the HDD 13.

The second processing unit 101 reads from the HDD 13 the topology information 130, the fault pattern information 139, the demand information 132, the route information 133, and the line information 134 and allocates the TS of each HO-ODU to each communication route, based on each information 132 to 134. The second processing unit 101 generates channel allocation information 135 representing an allocation result of the TS and records the generated channel allocation information 135 in the HDD 13.

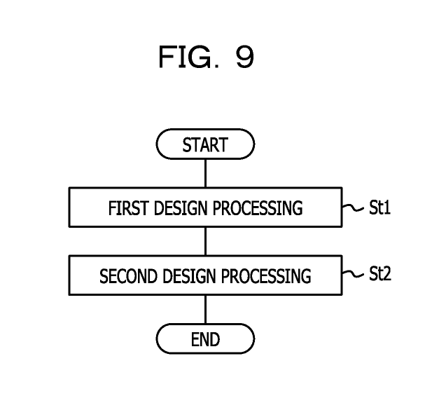

FIG. 9 is a flowchart illustrating a processing performed by the CPU 10. The CPU 10 first performs first design processing by the first processing unit 100 (step St1). As a result, the route information 133 and the line information 134 are generated.

Next, the CPU 10 performs a second design processing by the second processing unit 101 (step St2). As a result, the channel allocation information 135 is generated. As described above, the network designing apparatus 1 according to the embodiment divides and executes the design processing in two stages to effectively shorten a time required for designing. Hereinafter, contents of the first design processing and the second design processing will be described in detail.

(First Design Processing)

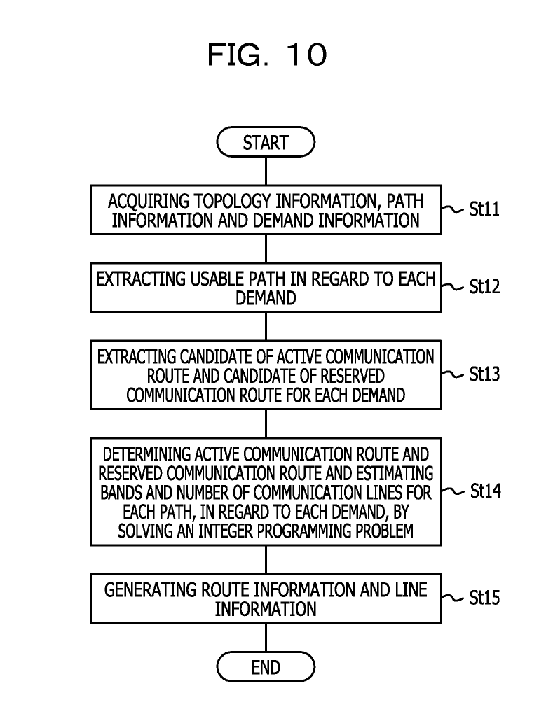

FIG. 10 is a flowchart illustrating the first design processing executed by the first processing unit 100. The first processing unit 100 acquires from the HDD 13 the topology information 130, the path information 131, and the demand information 132 (step St11).

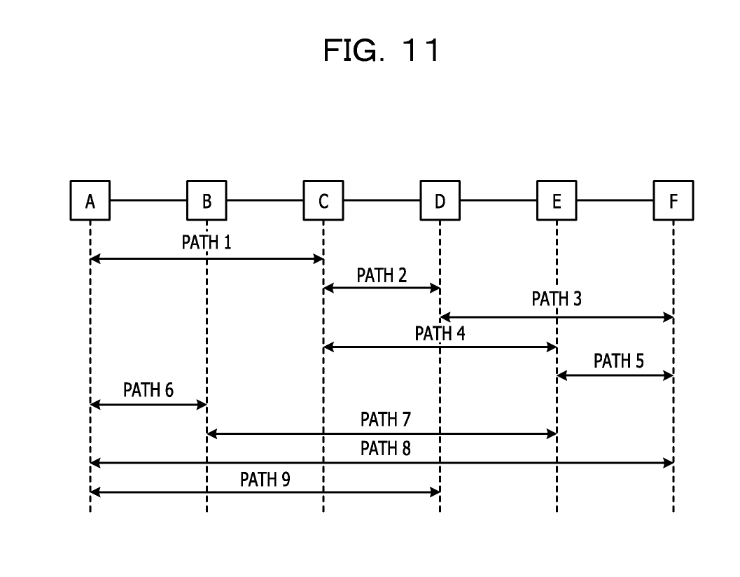

Next, the first processing unit 100 extracts a usable path in regard to each demand (step St12). FIG. 11 illustrates an example of paths formed in the network. Further, FIG. 11 exemplifies a simple network in which nodes A to F are connected in series for easy description and the WDM apparatus 20 is installed in each of the nodes A to F. Further, in the example, one set of nodes corresponding to the demand are node A and node F. Further, the first processing unit 100 may generate each path in step St12 and in this case, acquiring the path information 131 in step St11 is not necessary.

The first processing unit 100 extracts a plurality of paths 1 to 9 that exists between the nodes A and F corresponding to the demand, from one or more paths formed in the network. That is, the paths 1 to 9 are extracted as paths which may become at least a part of the communication route that connects the nodes A and F. For example, the path 1 connects the nodes A and C and further the path 2 connects the nodes C and D.

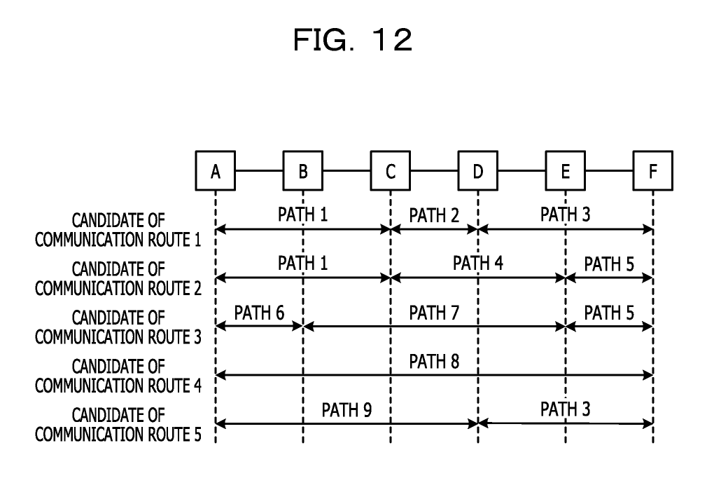

Next, the first processing unit 100 selects one or more paths for each demand to extract a candidate of the working communication route and a candidate of the protecting communication route (step St13). FIG. 12 illustrates a candidate of the communication route constituted by the paths 1 to 9 illustrated in FIG. 11. Further, the communication route illustrated in FIG. 12 may be any one of the candidate of the working communication route and the candidate of the protecting communication route.

For example, candidate 1 of the communication route includes path 1, path 2, and path 3 and further, candidate 2 of the communication route includes path 1, path 4, and path 5. As described above, candidates 1 to 5 of each communication route are extracted as a combination of one or more paths.

Next, the first processing unit 100 determines the working communication route and the protecting communication route and estimates the bandwidths and the number of HO-ODUs for each path, in regard to each demand, by solving an integer programming problem (step St14). A model of the integer programming problem constructed by the first processing unit 100 will be described below.

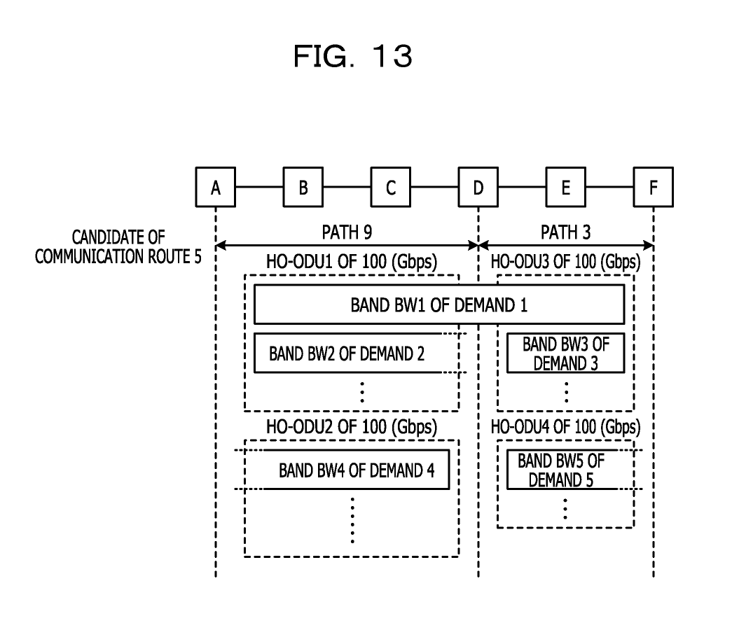

FIG. 13 illustrates an example of the HO-ODU required in the path. In the example, the first processing unit 100 selects the candidate 5 among the candidates 1 to 5 of the communication route illustrated in FIG. 12 as the communication route of the demand. The selected communication route includes path 9 and path 3.

The first processing unit 100 estimates the numbers of HO-ODUs required in the paths 9 and 3, respectively. The estimation is performed for each type of bandwidth of the communication line. The type of bandwidth may include the ODU2, the ODU3, and the ODU4. As described above, the communication line is estimated for each type of the bandwidth to perform flexible design depending on demands of various bandwidths.

The first processing unit 100 estimates the number of HO-ODUs so that total cost of the HO-ODU in the network is minimal. The cost of the HO-ODU is determined for each type of bandwidth, based on, for example, prices or maintenance cost of a transmitter and a receiver mounted in the WDM apparatus 20.

As a result of the estimation, two HO-ODUs, that is, HO-ODU 1 and HO-ODU 2 (“ODU4”) of 100 Gbps, are allocated to the path 9 as the communication line corresponding to the demand. The HO-ODU1 accommodates, for example, a bandwidth BW1 of demand 1, and a bandwidth BW2 of demand 2, and the HO-ODU2 accommodates a bandwidth BW4 of demand 4. Further, two HO-ODUs, that is, HO-ODU3 (“ODU4”) of 100 Gbps and HO-ODU4 (“ODU2”) of 10 Gbps, are allocated to the path 3. The HO-ODU3 accommodates, for example, the bandwidth BW1 of the demand 1, and a bandwidth BW3 of demand 3, and the HO-ODU4 accommodates a bandwidth BW5 of demand 5.

The first processing unit 100 permits sharing one or more paths between a plurality of protecting communication routes in determining the protecting communication route. Whether the sharing of the path is permitted is determined according to sharing availability information, which is included in the demand information 132 as already described. As a result, the first processing unit 100 enables sharing the bandwidth of the HO-ODU required in the path between the protecting traffics.

The bandwidth sharing is permitted between a plurality of protecting communication routes which is not simultaneously used when the fault occurs in the working communication route because the SMR scheme is implemented. Accordingly, the first processing unit 100 estimates a maximum value of a protecting sharing bandwidth demanded by each link failure in the network and estimates the bandwidths and the number of HO-ODUs according to the maximum value, for each shared path.

In estimating the maximum value of the protecting sharing bandwidth, the first processing unit 100 gives a restriction for satisfying at least one of Conditions (1) and (2). In the case of Condition (1), the first processing unit 100 estimates the bandwidth of the communication line so that a ratio of a total bandwidth demanded for a plurality of communication routes sharing the path to a bandwidth shared between the plurality of communication routes is the maximum number (predetermined number) Nₘₐₓ or less.

That is, the first processing unit 100 estimates the bandwidth of the HO-ODU so that a ratio of a total bandwidth (a total bandwidth of the demand) of traffics to a sharing bandwidth of the HO-ODU is the maximum number Nₘₐₓ or less, in regard to the path. Further, the ratio is referred to as a “bandwidth ratio” in the following description.

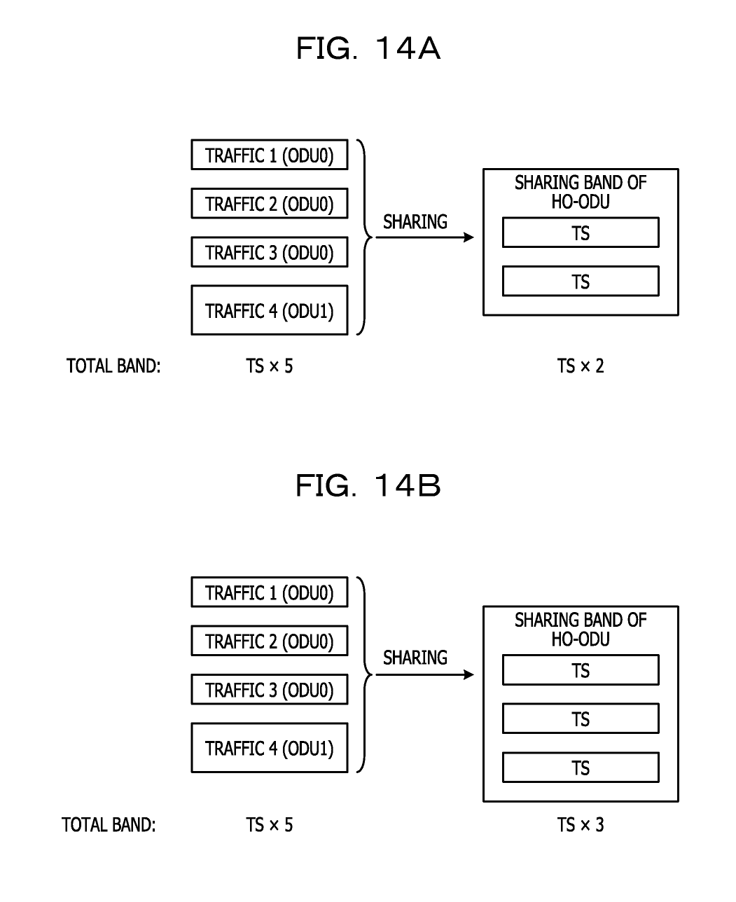

FIG. 14 illustrates one example of allocation of the sharing bandwidth of the HO-ODU for the demanded traffic. In more detail, FIG. 14A illustrates a case in which the sharing bandwidth is insufficient compared to the total bandwidth of the traffics and FIG. 14B illustrates a case in which the sharing bandwidth is sufficient to the total bandwidth of the traffics.

In FIG. 14, a description in parenthesis represents respective bandwidths of demanded traffics 1 to 4. Each of types of bandwidths of the traffics 1 to 3 is ODU0 (TS×1) and a type of bandwidth of the traffic 4 is ODU1 (TS×2). Therefore, a total bandwidth of the traffics 1 to 4 is TS×5. Further, a mark of “TS×n” (n is a natural number) represents bandwidths corresponding to n TSs and this is the same even in the following description.

In FIG. 14A, since it is assumed that the sharing bandwidth of the HO-ODU is TS×2, a bandwidth ratio becomes 2.5 (=5/2). In this case, when the maximum number Nₘₐₓ is 2, since the bandwidth ratio of 2.5 is larger than the maximum number, the sharing bandwidth of the HO-ODU is insufficient to the total bandwidth of the traffics 1 to 4.

Meanwhile, in FIG. 14B, since it is assumed that the sharing bandwidth of the HO-ODU is TS×3, the bandwidth ratio becomes 1.7 (=5/3 (round off the numbers to two decimal places). In this case, when the maximum number Nₘₐₓ is 2, since the bandwidth ratio of 1.7 is smaller than the maximum number, the sharing bandwidth of the HO-ODU is sufficient to the total bandwidth of the traffics 1 to 4.

As described above, the maximum number Nₘₐₓ represents the maximum number of traffics sharing one TS. In other words, the maximum number Nₘₐₓ is the maximum of an average value of the bandwidths of the traffics which one TS is capable of accommodating.

Since the bandwidth ratio is acquired by dividing the total bandwidth of the traffics by the protecting sharing bandwidth (=TS number) in the bandwidth of the HO-ODU, the bandwidth radio represents an average value of the bandwidths of the traffics accommodated in one TS of the sharing bandwidth. As a result, when the bandwidth radio is the maximum number Nₘₐₓ or less, it is determined that the sharing bandwidth of the HO-ODU is sufficient to the total bandwidth of the traffics. The first processing unit 100 estimates the sharing bandwidth of the HO-ODU by the judgment processing to design the HO-ODU so as to satisfy Condition (1) prior to the second design processing.

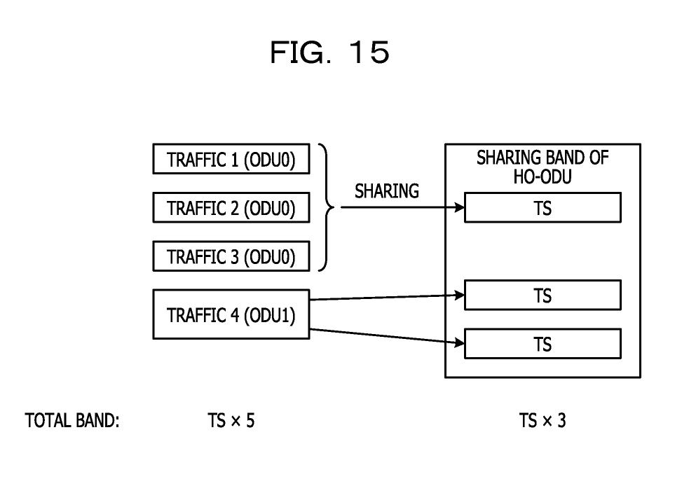

When the HO-ODU is designed so as to satisfy Condition (2), the first processing unit 100 estimates a bandwidth shared between communication routes sharing the path among the plurality of protecting communication routes for each type of the demanded bandwidth. That is, the first processing unit 100 estimates the sharing bandwidth of the HO-ODU for each type (type of the demand) of the bandwidths of the traffics. FIG. 15 illustrates one example of estimating the sharing bandwidth for each type of the bandwidth of the demanded traffic.

In FIG. 15, a description in parenthesis represents respective bandwidths of demanded traffics 1 to 4. Each of the types of bandwidths of the traffics 1 to 3 is ODU0 (TS×1) and a type of bandwidth of the traffic 4 is ODU1 (TS×2). Therefore, the total bandwidth of the traffics 1 to 4 is TS×5.

Since the traffics 1 to 3 have the same type (ODU0) of the bandwidth, one common TS is allocated to the traffics 1 to 3. Since the type (ODU1) of bandwidth in the traffic 4 is different from those of the traffics 1 to 3, two different TSs are allocated to the traffic 4. That is, the TS allocated to the traffics 1 to 3 and the TS allocated to the traffic 4 are discriminated from each other.

As described above, the first design processing unit 100 estimates the sharing bandwidth of the HO-ODU for each type of the bandwidth of the demanded traffic to design the HO-ODU so as to satisfy Condition (2) prior to the second design processing.

Referring back to FIG. 10, next, the first processing unit 100 generates the route information 133 and the line information 134 according to an estimation result (step St15). The route information 133 represents the working communication route and the protecting communication route as a set of one or more paths for each demand. The line information 134 represents the bandwidths and the number of HO-ODU for each path. The generated route information 133 and the line information 134 are used in the second design processing by the second processing unit 101. By this configuration, the first processing unit 100 performs the first design processing.

Next, in processing St14 as illustrated in FIG. 10, the model of the integer programming problem constructed by the first processing unit 100 will be described. The integer programming problem is a means for acquiring a solution having a predetermined function value to be minimum or maximum according to one or more restriction conditions. The model of the integer programming problem is constructed based on the topology information 130, the path information 131, the fault pattern information 139, and the demand information 132.

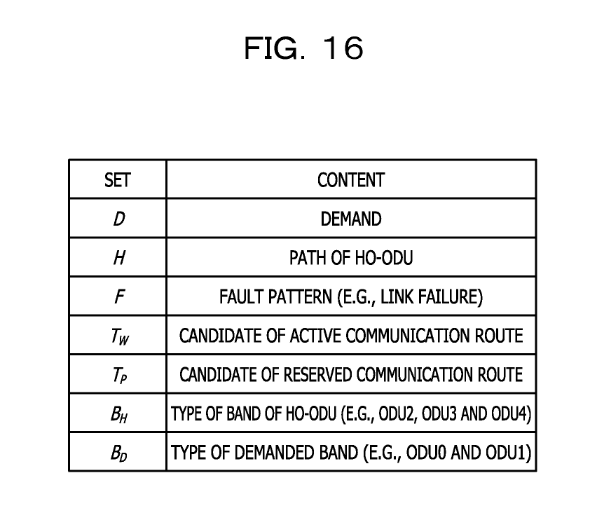

FIG. 16 illustrates the content of a set used for the model of the integer programming problem constructed by the first processing unit 100. A set D is a set of all demands. A set F is a set of all fault patterns generated in the network. The fault patterns may include, for example, a link failure between nodes, that is, a failure in transmission path or a transmitter and a receiver of the WDM apparatus 20.

A set H is a set of all paths formed in the network. Each path is constituted by one or more links in the network. A set T_{W} is a set of all candidates of the working communication route and a set T_{P} is a set of all candidates of the protecting communication route. A set B_{H} is a set of all types (e.g., “ODU2”, “ODU3” and “ODU4” described above) of the bandwidth of the HO-ODU.

A set B_{D} is a set of the types (e.g., “ODU0” and “ODU1” described above) of the demanded bandwidth. Further, the set B_{D} is used only in the case of performing design to satisfy Condition 2.

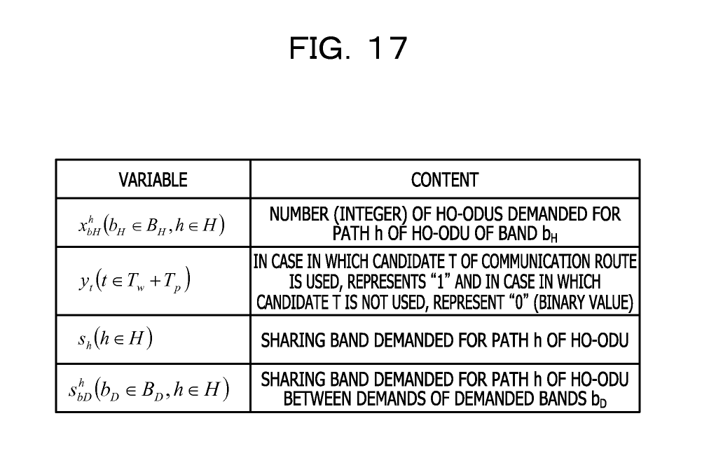

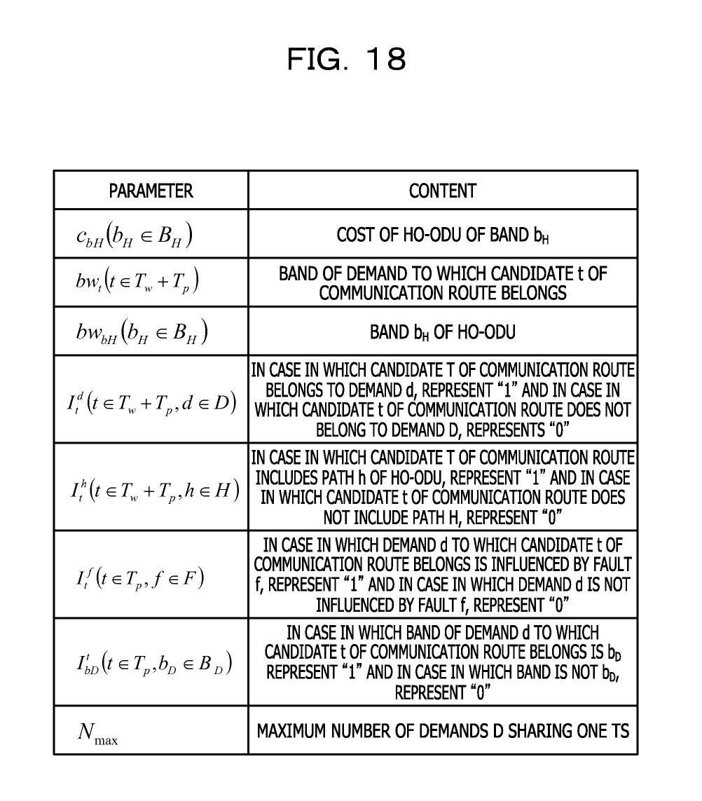

The first processing unit 100 uses, for example, Equation (1) shown below as an objective function. FIGS. 17 and 18 illustrate a content of a variable and a content of a parameter used in the model of the integer programming problem constructed by the first processing unit 100, respectively.

$$Minimize \text{:} {\sum }_{h ∈ H , {b}_{H} ∈ {B}_{H}}^{ } {C}_{bH} \cdot {x}_{bH}^{h} \qquad ( 1 )$$

According to Equation (1), the first processing unit 100 estimates the bandwidths and the number of HO-ODUs so that the total cost of the HO-ODU in the network is minimum. The total cost of the HO-ODU is calculated as a sum total of a multiplication of cost and the number for every type of the bandwidth.

A restriction condition varies depending on selection of Conditions (1) and (2) to be satisfied. When only Condition (1) is selected, the first processing unit 100 uses, for example, Equations (2) to (6) shown below as the restriction condition.

$$\begin{matrix}{\sum }_{t ∈ {T}_{w}}^{ } {I}_{t}^{d} \cdot {y}_{t} = 1 ( for ∀ d ∈ D ) & ( 2 ) \\ {\sum }_{t ∈ Tp}^{ } {I}_{t}^{d} \cdot {y}_{t} = 1 ( for ∀ d ∈ D ) & ( 3 ) \\ {\sum }_{t ∈ Tw}^{ } {I}_{t}^{h} \cdot {bw}_{t} \cdot {y}_{t} + {s}_{h} - {\sum }_{{b}_{H} ∈ {B}_{H}}^{ } {bw}_{bH} \cdot {x}_{{b}_{H}}^{h} \leq 0 ( for ∀ h ∈ H ) & ( 4 ) \\ {\sum }_{t ∈ Tp}^{ } {I}_{t}^{h} \cdot {I}_{t}^{f} \cdot {bw}_{t} \cdot {y}_{t} - {s}_{h} \leq 0 ( for ∀ h ∈ H , ∀ f ∈ F ) & ( 5 ) \\ {\sum }_{t ∈ Tp}^{ } {I}_{t}^{h} \cdot {bw}_{t} \cdot {y}_{t} - {N}_{max} \cdot {s}_{h} \leq 0 ( for ∀ h ∈ H ) & ( 6 )\end{matrix}$$

Equations (2) and (3) represent a restriction condition (first restriction condition) having one of a plurality of working communication routes and one of a plurality of protecting communication routes selected from a plurality of communication route candidates acquired by selecting one or more paths in regard to each demand, respectively. That is, the first processing unit 100 selects one working communication route and one protecting communication route from candidates of the plurality of communication routes illustrated in FIG. 12 for each demanded traffic.

Equation (4) represents a restriction condition (second restriction condition) in which a total bandwidth of communication lines is equal to or more than a sum of a total bandwidth of the communication route including the path among the plurality of working communication routes and a bandwidth shared among the plurality of protecting communication routes, in regard to each of one or more paths. That is, as illustrated in FIG. 13, the first processing unit 100 estimates the bandwidths and the number of the HO-ODUs so that the bandwidth of the HO-ODU required in each path is equal to or more than a total bandwidth of a demand in which the path is included in the communication route and a sum of the protecting sharing bandwidths demanded in the path.

Equation (5) represents a restriction condition (third restriction condition) in which the bandwidths shared among the plurality of protecting communication routes are equal to or more than a total bandwidth of a plurality of communication routes that shares the path and is simultaneously used when a fault occurs in any one of the plurality of working communication routes, among the plurality of protecting communication routes in regard to each of one or more paths. The restriction condition needs to be satisfied in association with the all fault patterns F.

Therefore, when the fault pattern is limited to a single link fault, a sharing bandwidth Sₕ is estimated to be a maximum value or more of the protecting bandwidth demanded by each link fault in the network. For example, when a protecting sharing bandwidth demanded by any link fault is 1 Gbps and a protecting sharing bandwidth demanded by other link fault is 2 Gbps, in a specific path, the sharing bandwidth demanded for the path is estimated to be equal to or more than 2 Gbps.

Equation (6) represents a restriction condition (fourth restriction condition) in which a ratio of the total bandwidth of the communication route including the path among the plurality of protecting communication routes to the bandwidth shared among the plurality of protecting communication routes is equal to or less than the maximum number Nₘₐₓ, in regard to each of one or more paths. That is, as described with reference to FIG. 14, the protecting sharing bandwidth is estimated so that the bandwidth ratio is equal to or less than the maximum number Nₘₐₓ in order to satisfy Condition (1), in regard to the bandwidth of the HO-ODU required in each path.

$$\begin{matrix}{\sum }_{t ∈ Tw}^{ } {I}_{t}^{h} \cdot {bw}_{t} \cdot {y}_{t} + {\sum }_{{b}_{H} ∈ {B}_{H}}^{ } {S}_{bD}^{h} - {\sum }_{{b}_{H} ∈ {B}_{H}}^{ } {bw}_{bH} \cdot {x}_{bH}^{h} \leq 0 ( for ∀ h ∈ H ) & ( 7 ) \\ {\sum }_{t ∈ Tp}^{ } {I}_{t}^{h} \cdot {I}_{t}^{f} \cdot {I}_{bD}^{t} \cdot {bw}_{t} \cdot {y}_{t} - {s}_{bD}^{h} \leq 0 ( for ∀ h ∈ H , ∀ f ∈ F , ∀ {b}_{D} ∈ {B}_{D} ) & ( 8 ) \\ {\sum }_{t ∈ Tp}^{ } {I}_{t}^{h} \cdot {I}_{bD}^{t} \cdot {bw}_{t} \cdot {y}_{t} - {N}_{max} \cdot {S}_{bD}^{h} \leq 0 ( for ∀ h ∈ H , ∀ {b}_{D} ∈ {B}_{D} ) & ( 9 )\end{matrix}$$

Meanwhile, when both Conditions (1) and (2) are selected, the first processing unit 100 uses, for example, Equations (7) to (9) shown below instead of Equations (4) to (6) shown above as the restriction condition. Further, even in this case, a restriction condition (ninth restriction condition) represented in Equations (2) and (3) above is similarly given.

Equation (7) represents a restriction condition (tenth restriction condition) in which a total bandwidth of communication lines is equal to or more than a sum of a total bandwidth of the communication route including the path among the plurality of working communication routes and bandwidths shared among the plurality of protecting communication routes, in regard to each of one or more paths. A content of Equation (7) is the same as that of Equation (4), but in order to consider Condition (2), a variable S^{h}_{bD} is used for each type of the demanded bandwidth instead of the sharing bandwidth Sₕ. Accordingly, in Equation (7), an expression of a second term representing the sharing bandwidth is different from that of Equation (4).

Equation (8) represents a restriction condition (eleventh restriction condition) in which the bandwidths shared among the plurality of protecting communication routes are equal to or more than a total bandwidth of a plurality of communication routes that shares the path and is simultaneously used when a fault occurs in any one of the plurality of working communication routes, among the plurality of protecting communication routes in regard to each of one or more paths, for each type of the demanded bandwidth. The restriction condition needs to be satisfied in association with the all fault patterns F.

Equation (8) is acquired by changing an expression so as to give the restriction condition of Equation (5) for each type of the bandwidth of the demanded traffic. That is, as described with reference to FIG. 15, the protecting sharing bandwidth is estimated for each type of the bandwidth of the demanded traffic in order to satisfy Condition (2), in regard to the bandwidth of the HO-ODU required in each path.

Equation (9) represents a restriction condition (twelfth restriction condition) in which a ratio of the total bandwidth of the communication route including the path among the plurality of protecting communication routes to the bandwidth shared among the plurality of protecting communication routes is equal to or less than the maximum number Nₘₐₓ, in regard to each of one or more paths, for each type of the demanded bandwidth. Equation (9) is acquired by changing an expression so as to give the restriction condition of Equation (6) for each type of the bandwidth of the demanded traffic.

In the case of the estimation of the protecting sharing bandwidth illustrated in FIG. 14 as an example, the sharing bandwidths are separately estimated according to the restriction condition of Equation (9) for the traffics 1 to 3 of which the type of bandwidth is ODU0 and the traffic 4 of which the type of bandwidth is ODU1. Further, when only Condition (2) is selected, the restriction condition of Equation (9) is not used.

The first processing unit 100 acquires the solution to satisfy Equation (1) according to the restriction conditions of Equations (2) to (9) to determine the working and protecting communication routes depending on each demand and estimate the bandwidths and the number of HO-ODUs for each path. As a result, a time required for the first design processing is effectively shortened. Further, in the embodiment, an integer programming method is described as an analysis technique, but the analysis technique is not limited thereto and other technique such as a heuristic method may be used.

(Second Design Processing)

The second processing unit 101 performs the second design processing based on the topology information 130, the fault pattern information 139, the demand information 132, the route information 133 and the line information 134 generated by the first processing unit 100. The second processing unit 101 allocates the TS of each HO-ODU to the plurality of working communication routes and the plurality of protecting communication routes represented by the route information 133, based on the bandwidth of each demand. Each HO-ODU has the number of TSs according to the bandwidths as described above.

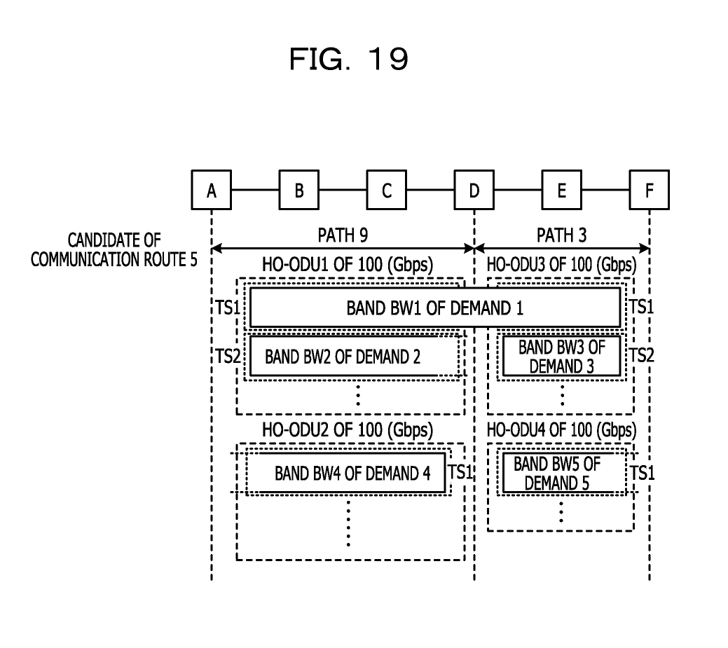

FIG. 19 illustrates an example of the allocation of the TS of the HO-ODU illustrated in FIG. 13. For example, the TS1 of the HO-ODU1 is allocated to the communication route of the demand 1 and accommodates the bandwidth BW1 of the demand 1. Further, the TS2 of the HO-ODU1 is allocated to the communication route of the demand 2 and accommodates the bandwidth BW2 of the demand 2. As described above, the HO-ODU is allocated to the communication route of each demand by the unit of the TS to efficiently operate a network resource.

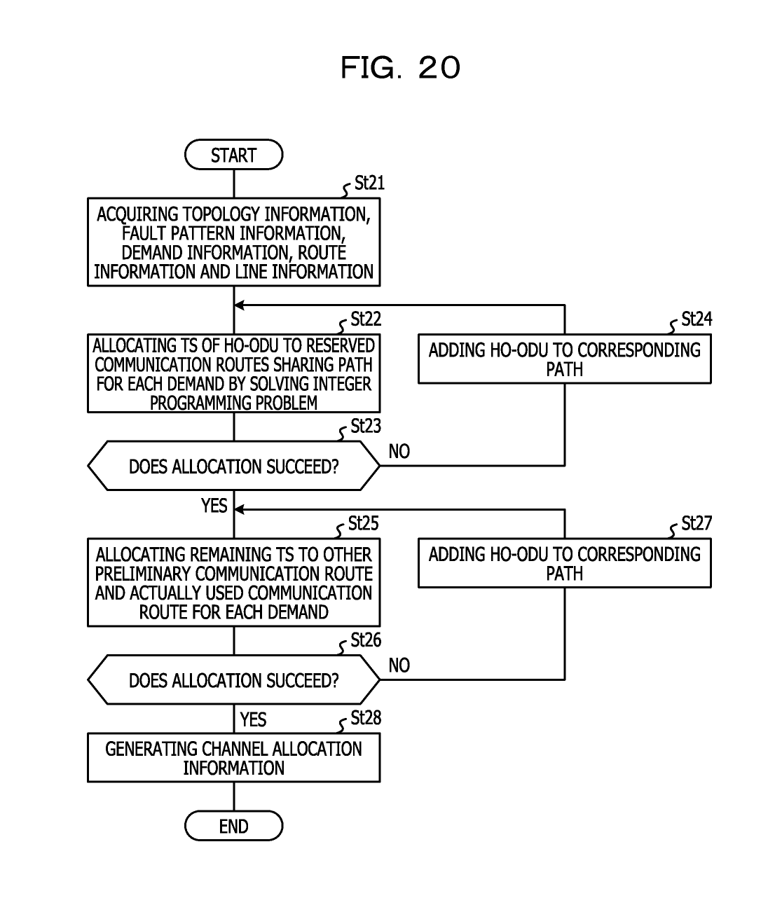

FIG. 20 is a flowchart illustrating the second design processing executed by the second processing unit 101. First, the second processing unit 101 reads from the HDD 13 the topology information 130, the fault pattern information 139, the demand information 132, the route information 133, and the line information 134 (step St21).

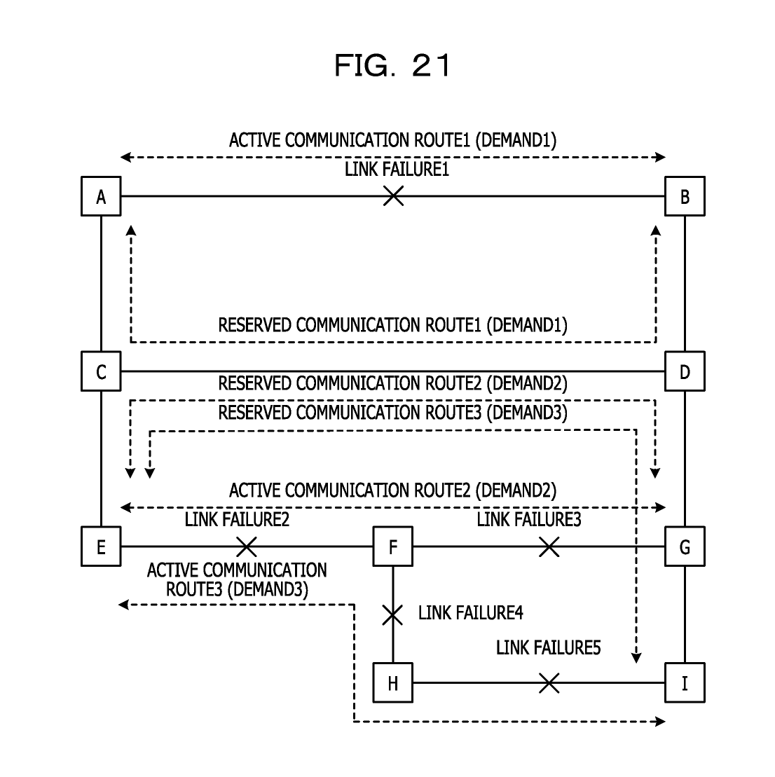

Next, the second processing unit 101 allocates the TS of the HO-ODU to the protecting communication routes (communication routes in which sharing the path is permitted according to the sharing availability information included in the demand information 132) sharing the path for each demand by solving the integer programming problem (step St22). The second processing unit 101 allocates a common TS to a plurality of communication routes that is not simultaneously used among the plurality of protecting communication routes of the working communication routes when the fault occurs in the plurality of working communication routes that shares one or more paths. Hereinafter, the communication routes will be described in detail with reference to FIGS. 21 to 24.

FIG. 21 illustrates an example of the working communication route and the protecting communication route in the network. In the example, working communication route 1 of the demand 1 is determined as a path that connects nodes A and Bandwidth the protecting communication route 1 is determined as a path that connects the node A, node C, node D, and the node B. Working communication route 2 of the demand 2 is determined as a path that connects node E, node F, and node G and protecting communication route 2 is determined as a path that connects the node E, the node C, the node D, and the node G. Working communication route 3 of the demand 3 is determined as a path that connects the node E, the node F, node H, and node I and protecting communication route 3 is determined as a path that connects the node E, the node C, the node D, the node G, and the node I.

The protecting communication routes 1 to 3 of the demands 1 to 3 share a path that connects the nodes C and D. As a result, in step St22, the second processing unit 101 allocates the TS of the HO-ODU required in the path. Further, in the example, a bandwidth of the demand 1 is set as 2.5 Gbps (that is, the number of TSs=2) and each of bandwidths of the demands 2 and 3 is set as 1.25 Gbps (that is, the number of TSs=1).

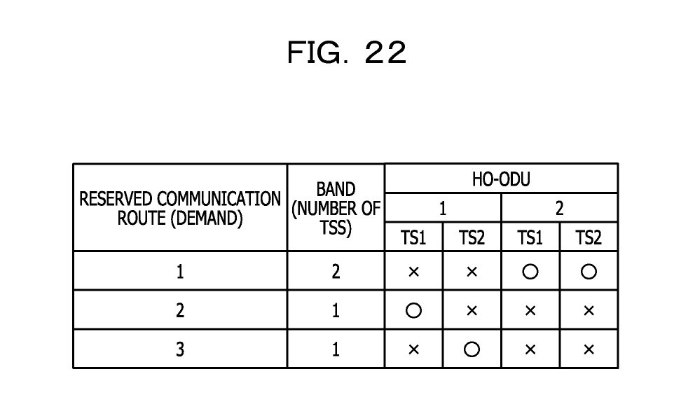

When sharing of the TS is not permitted and the TS is allocated to the protecting communication routes 1 to 3 of the demands 1 to 3, the HO-ODU of the bandwidth to satisfy a total of all bandwidths of the demands 1 to 3 is demanded in the path that connects the nodes C and D. FIG. 22 illustrates a comparative example of allocation of the TS to the protecting communication route illustrated in FIG. 21 in this case. In FIG. 22, a circle symbol (∘) represents that the TS is allocated and a cross symbol (x) represents that the TS is not allocated.

In the example, two HO-ODUs, that is, HO-ODU1 and HO-ODU2, are demanded to satisfy all bandwidths of the demands 1 to 3. Two HO-ODUs, that is, TS1 and TS2 of the HO-ODU2, are allocated to the protecting communication route 1 of the demand 1. Further, TS1 of TS1 and TS2 which are two logical channels of the other HO-ODU1 is allocated to the protecting communication route 2 of the demand 2, and TS2 is allocated to the protecting communication route 3 of the demand 3. That is, in the example, individual TSs are allocated to the protecting communication routes 1 to 3 of the demands 1 to 3.

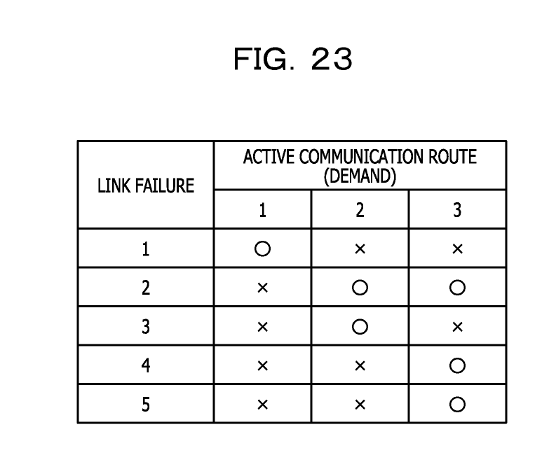

In this regard, the second processing unit 101 allocates the TS by permitting sharing the TS among the protecting communication routes 1 to 3 of the respective demands 1 to 3 by considering the fault that occurs in the working communication route. FIG. 23 illustrates the working communication route in which the fault occurs by the link failure in the network illustrated in FIG. 21. Link failures 1 to 5 represent failures of respective links included in the working communication routes 1 to 3 illustrated in FIG. 21 (see the cross symbol x in FIG. 21). Further, in FIG. 23, the circle symbol (∘) represents that the fault occurs in the communication route by the link failure and the cross symbol (x) represents that no fault occurs in the communication route by the link fault.

For example, when the link failure 1 occurs, the working communication route 1 of the demand 1 includes a path between the corresponding nodes A and Bandwidth as a result, the fault occurs, but the communication routes 2 and 3 of other demands 2 and 3 do not include the path, and as a result, the fault does not occur. Further, when the link failure 2 occurs, the working communication routes 2 and 3 of the demands 2 and 3 include a path between the corresponding nodes E and F, and as a result, the fault occurs, but the working communication route 1 of the demand 1 does not include the path, and as a result, the fault does not occur. In addition, when the link failure 3 occurs, a fault occurs only in the working communication route 2 of the demand 2, and when the link failures 4 and 5 occur, a fault occurs only in the working communication route 3 of the demand 3.

Therefore, the fault occurs in the working communication routes 2 and 3 of the demands 2 and 3 by the same link failure 2 and the fault does not occur simultaneously with the working communication route 1 of the demand 1. In other words, the protecting communication routes 2 and 3 of the demands 2 and 3 may be used simultaneously when the fault occurs, but are not used simultaneously with the protecting communication route 1 of the demand 1. Accordingly, according to the SMR scheme, the protecting communication routes 2 and 3 of the demands 2 and 3 may share the bandwidth with the protecting communication route 1 of the demand 1 and the common TS may be allocated to the protecting communication routes 2 and 3 of the demands 2 and 3 and the protecting communication route 1 of the demand 1.

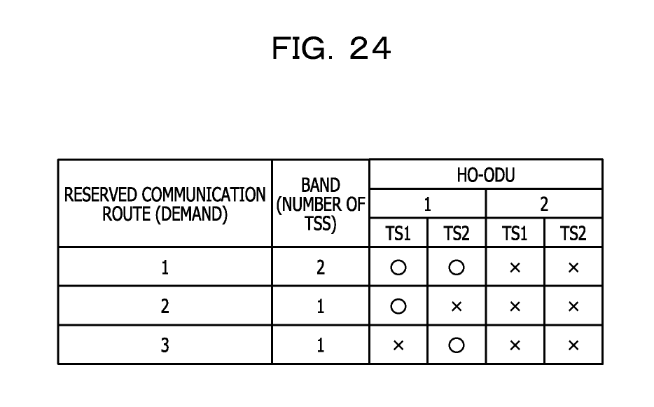

FIG. 24 illustrates an example of allocation of the TS to the protecting communication route illustrated in FIG. 21. In FIG. 24, the circle symbol (∘) represents that the TS is allocated and the cross symbol (x) represents that the TS is not allocated.

As described above, the common TS may be allocated to the protecting communication routes 2 and 3 of the demands 2 and 3 and the protecting communication route 1 of the demand 1. Accordingly, the TS1 and the TS2 of the HO-ODU1 are allocated to the protecting communication route 1 of the demand 1 based on the demanded bandwidth (the number of TSs=2). Further, the TS1 and the TS2 of the HO-ODU1 are allocated to the protecting communication routes 2 and 3 of the demands 2 and 3, respectively, based on the demanded bandwidth (the number of TSs=1). As a result, unlike the comparative example of FIG. 22, other HO-ODU2 need not be used, and as a result, the network resource may be efficiently used.

The TS is fixedly allocated to the protecting communication routes 1 to 3 of the respective demands 1 to 3. In the example of FIG. 24, the TS1 is fixedly allocated to the protecting communication route 2 of the demand 2 and the TS2 is not allocated to the protecting communication route 2 of the demand 2. Further, the TS2 is fixedly allocated to the protecting communication route 3 of the demand 3 and the TS1 is not allocated to the protecting communication route 3 of the demand 3. That is, the second processing unit 101 does not dynamically allocate the logical channel.

When Condition (1) is selected, the second processing unit 101 shares one or more paths among the plurality of protecting communication routes and allocates the common logical channel to communication routes of the maximum number Nₘₐₓ or less which are not simultaneously used when the fault occurs in the plurality of working communication routes. In the example of FIG. 24, since each of the TS1 and the TS2 is allocated to two communication routes, Condition (1) is satisfied when the maximum number Nₘₐₓ is 2.

When Condition (2) is selected, the second processing unit 101 allocates the common logical channel to the communication routes of which the types of demanded bandwidth are the same as each other, among the plurality of protecting communication routes. In the example of FIG. 24, since the demand 1 has a different bandwidth type from the demands 2 and 3 and each of the TS1 and the TS2 is allocated to two communication routes of which the bandwidth types are different from each other, Condition (2) is not satisfied.

As a result, the second processing unit 101 adds an HO-ODU that can be allocated to perform the allocation illustrated in the example of FIG. 22, as described below. In the example of FIG. 22, since the number of types of bandwidths of communication routes to which each of the TS1 and the TS2 of the HO-ODU1 and HO-ODU2 is allocated is one, Condition (2) is satisfied.

The second processing unit 101 performs the TS allocation processing by solving an integer programming problem to be described below. Referring back to FIG. 20, the second processing unit 101 determines whether the allocation of the TS succeeds (step St23).

When it is determined that the allocation fails (“NO” at step St23), that is, when the TSs allocated to the protecting communication routes sharing the path are insufficient, the second processing unit 101 executes allocation again (step St22) by adding the HO-ODU to the corresponding path (step St24). As a result, the second processing unit 101 increases the number of TSs by modifying the number of HO-ODUs estimated by the first processing unit 100 to allocate the TS.

Meanwhile, when it is determined that the allocation succeeds (“YES” at step St23), that is, when the TSs allocated to the protecting communication routes sharing the path are sufficient, the second processing unit 101 allocates remaining TSs that are not allocated by the processing of step St22, to other protecting communication routes (protecting communication routes which are not permitted to share the path according to the sharing availability information) and working communication routes, in regard to each demand (step St25). In this case, the second processing unit 101 allocates the TS by the same technique as described with reference to FIG. 22. That is, the communication route of each demand is not permitted to share the TS and the individual TSs are allocated to the communication routes of the respective demands. Accordingly, the protecting communication routes and the working communication routes that do not share the path have no sharing bandwidth but individual bandwidths.

Next, the second processing unit 101 determines whether the allocation of the TS succeeds (step St26). When it is determined that the allocation fails (“NO” at step St26), that is, when the TSs are insufficient, the second processing unit 101 executes allocation again (step St25) by adding the HO-ODU to the corresponding path (step St27). As a result, the second processing unit 101 increases the number of TSs by modifying the number of HO-ODUs estimated by the first processing unit 100 to allocate the TS.

Next, the second processing unit 101 generates the channel allocation information 135 that represents the allocation of the TS, in regard to each demand (step St28). The generated channel allocation information 135 is transmitted to each WDM apparatus 20 through the monitoring control network NW by the communication processing unit 14 of FIG. 3. Each WDM apparatus 20 reflects the received channel allocation information 135 to a set-up thereof. By this configuration, the second processing unit 101 performs the second design processing.

Next, in processing St22 illustrated in FIG. 20, the model of the integer programming problem constructed by the second processing unit 101 will be described. The model of the integer programming problem is constructed based on the topology information 130, the fault pattern information 139, the demand information 132, the route information 133, and the line information 134.

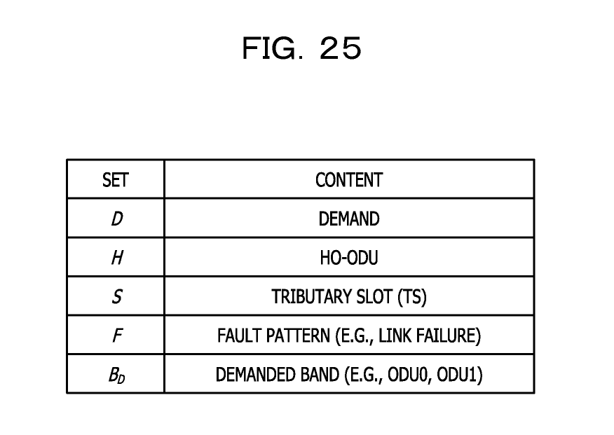

FIG. 25 illustrates a content of a set used for the model of the integer programming problem constructed by the second processing unit 101. A set D is a set of all demands. A set H is a set of all HO-ODUs included in the line information 134. Further, the second processing unit 101 modifies a content of the set H when adding the HO-ODU (steps St24 and St27).

A set S is a set of TSs of all HO-ODUs included in the line information 134. Further, the second processing unit 101 modifies a content of the set S when adding the HO-ODU (steps St24 and St27).

A set F is a set of all fault patterns generated in the network. The fault pattern is, for example, the link failure illustrated in FIGS. 21 and 23.

A set B_{D} is a set of the types (e.g., “ODU0” and “ODU1” described above) of bandwidth of the demanded traffic. Further, the set B_{D} is used only in the case of performing design to satisfy Condition 2.

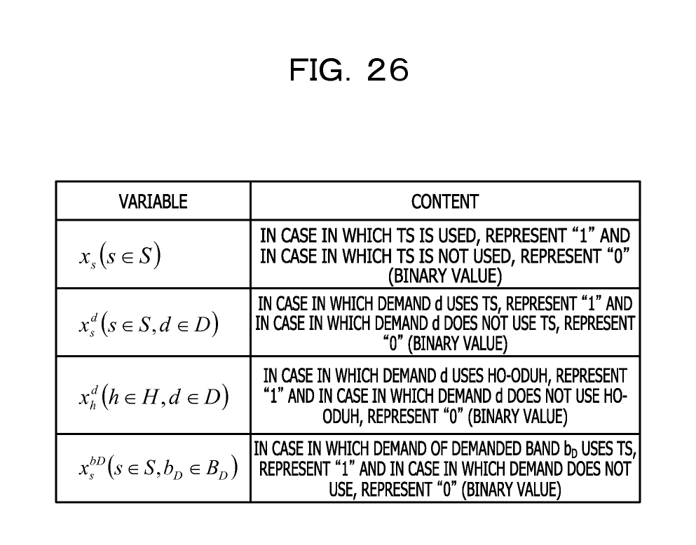

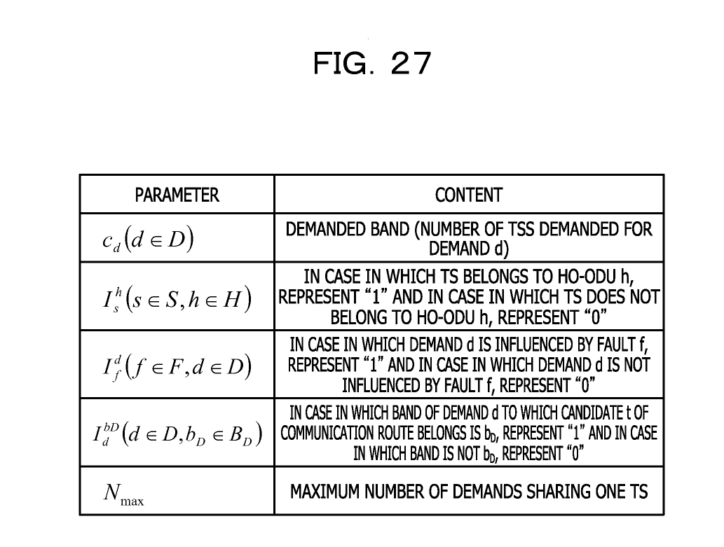

The second processing unit 101 uses, for example, Equation (10) shown below as an objective function. FIGS. 26 and 27 illustrate a content of a variable and a content of a parameter used in the model of the integer programming problem constructed by the second processing unit 101, respectively.

$$Minimize \text{:} {\sum }_{s ∈ S}^{ } {x}_{s} \qquad ( 10 )$$

According to Equation (10), the second processing unit 101 allocates the TSs to the plurality of protecting communication routes sharing one or more paths, respectively so that the number of TSs used in the network is minimum. As a result, the network resource may be efficiently used as described.

The second processing unit 101 uses, for example, Equations (11) to (18) shown below as the restriction condition when performing design to satisfy both Conditions (1) and (2).

$$\begin{matrix}{\sum }_{s ∈ S}^{ } {x}_{s}^{d} = {c}_{d} ( for ∀ d ∈ D ) & ( 11 ) \\ {\sum }_{h ∈ H}^{ } {x}_{h}^{d} = 1 ( for ∀ d ∈ D ) & ( 12 ) \\ {\sum }_{s ∈ S}^{ } {I}_{s}^{h} \cdot ( {x}_{s}^{d} - {x}_{h}^{d} ) \leq 0 ( for ∀ d ∈ D , ∀ h ∈ H ) & ( 13 ) \\ {\sum }_{d ∈ D}^{ } {I}_{f}^{d} \cdot {x}_{s}^{d} \leq 1 ( for ∀ s ∈ S , ∀ f ∈ F ) & ( 14 ) \\ {\sum }_{d ∈ D}^{ } ( {x}_{s}^{d} - {x}_{s} ) \leq 0 ( for ∀ s ∈ S ) & ( 15 ) \\ {\sum }_{d ∈ D}^{ } {x}_{s}^{d} \leq {N}_{max} ( for ∀ s ∈ S ) & ( 16 ) \\ {\sum }_{BD ∈ BD}^{ } {x}_{s}^{bD} = 1 ( for ∀ s ∈ S ) & ( 17 ) \\ {\sum }_{d ∈ D}^{ } {I}_{d}^{bD} \cdot ( {x}_{s}^{d} - {x}_{s}^{bD} ) \leq 0 ( for ∀ s ∈ S , ∀ d ∈ D ) & ( 18 )\end{matrix}$$

Equation (11) represents restriction conditions (a fifth restriction condition and a thirteenth restriction condition) in which the number of TSs allocated to the plurality of protecting communication routes, respectively is set to the number suitable for the bandwidth of the demand. Referring to FIG. 24 as an example, since the bandwidth of the demand 1 is 2.5 Gbps, the bandwidth is accommodated in two TSs and since each of the bandwidths of the demands 2 and 3 is 1.25 Gbps, the bandwidths are accommodated in one TS.

Equations (12) and (13) represent restriction conditions (a sixth restriction conditions and a fourteenth restriction condition) in which the number of HO-ODUs used in the plurality of protecting communication routes, respectively is one. Referring to FIG. 24 as an example, the TS1 and the TS2 allocated to the protecting communication route 1 of the demand 1 belong to the same HO-ODU1. That is, the TSs of two different HO-ODUs are not permitted to be allocated to the working communication route and the protecting communication route of each demand, respectively.

Equation (14) represents restriction conditions (a seventh restriction condition and a fifteenth restriction condition) in which the maximum number of the plurality of protecting communication routes using the TSs, respectively is one when the fault occurs in the plurality of working communication routes. Referring to FIGS. 23 and 24 as an example, when the link failure 1 occurs, each of the TS1 and the TS2 of the HO-ODU1 is used by only the protecting communication route 1 of the demand 1 and not used by the protecting communication routes 2 and 3 of other demands 2 and 3. Further, when the link failure 2 occurs, the TS1 of the HO-ODU1 is used by only the protecting communication route 2 of the demand 2 and the TS2 of the HO-ODU1 is used by only the protecting communication route 3 of the demand 3.

Equation (15) represents a restriction condition on the equation in which a variable xₛ is 1 when each TS is used in the protecting communication route of at least one demand.

Equation (16) represents restriction conditions (an eighth restriction condition and a sixteenth restriction condition) in which the number of the plurality of protecting communication routes to which the logical channel is allocated is the maximum number (predetermined number) Nₘₐₓ or less, in regard to each TS. Referring to FIGS. 4 and 6 as an example, each of the TS1 to TS4 is limited so that the sharing number N becomes the maximum number Nₘₐₓ (=2) or less. Further, the restriction condition of Equation (16) is not used when Condition (1) is not selected.

Equations (17) and (18) represent a restriction condition (a seventh restriction condition) in which the type of the demanded bandwidth is one in regard to the plurality of protecting communication routes to which the TS is allocated for each TS. Referring to FIGS. 5 and 6 as an example, the TS1 to the TS4 are limited so that the types of the bandwidths of the traffics 1 to 4 of allocation destinations are the same as each other. Further, the restriction conditions of Equations (17) and (18) are not used when Condition (2) is not selected.

The second processing unit 101 allocates the TSs to the plurality of protecting communication routes sharing one or more paths, respectively by acquiring a solution to satisfy Equation (10) according to the restriction conditions of Equations (11) to (18). As a result, a demanded time for the second design processing is effectively shortened. Further, in the embodiment, an integer programming method is described as an analysis technique, but the analysis technique is not limited thereto and other technique such as a heuristic method may be used.

As described above, the network designing apparatus 1 estimates the number and the bandwidths of HO-ODUs by considering at least one of Conditions (1) and (2) in the first design processing. As a result, in the network designing apparatus 1, occurrence of the addition processing (step St24 of FIG. 20) of the HO-ODU in the second design processing is suppressed. Accordingly, a design time is shortened.

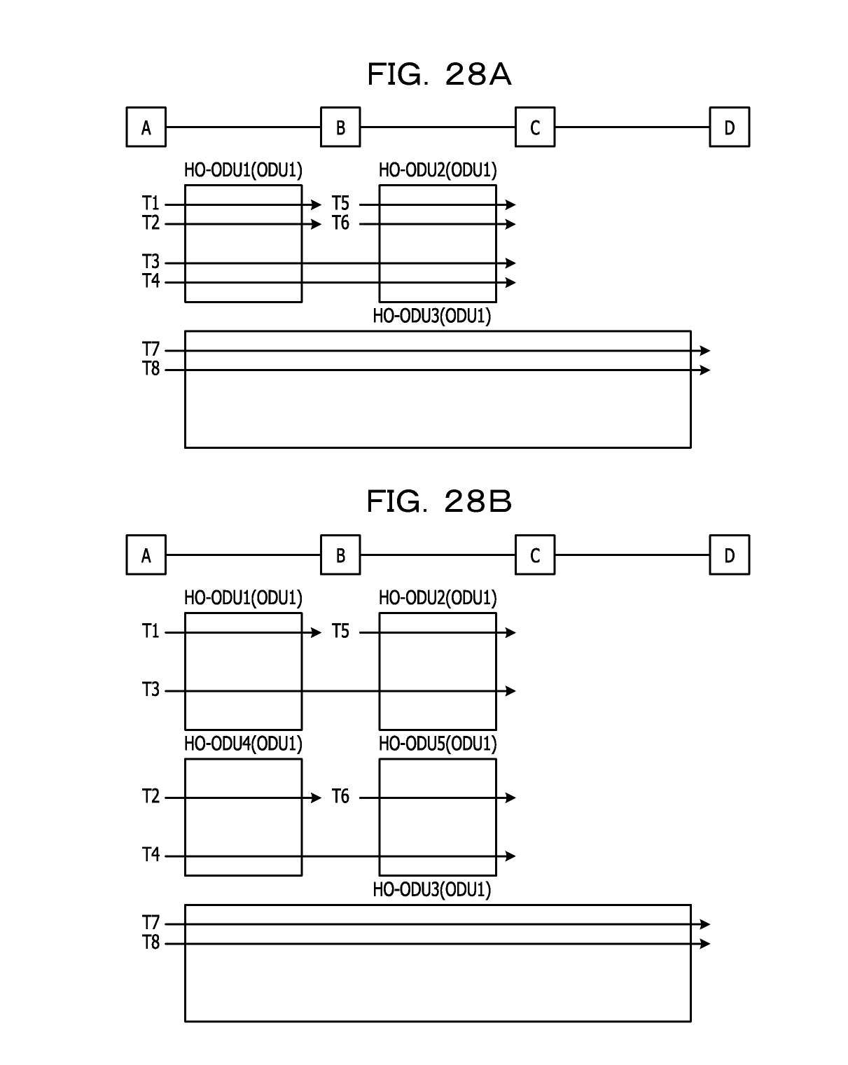

FIG. 28 illustrates one example of results of the first design processing and the second design processing in a comparative example. In more detail, FIG. 28A illustrates the result of the first design processing and FIG. 28B illustrates the result of the second design processing. In the comparative example, Conditions (1) and (2) are considered not in the first design processing, but only in the second design processing.

In the example, in a network in which the nodes A to D are connected in series, an HO-ODU housing the demanded traffics T1 to T8 is designed. The traffics T1 and T2 have a communication route between the nodes A and B. The traffics T5 and T6 have a communication route between the nodes Bandwidth C. The traffics T3 and T4 have a communication route between the nodes A and C. The traffics T7 and T8 have a communication route between the nodes A and D.

As illustrated in FIG. 28A, as the result of the first design processing, the traffics T1 and T2 are accommodated in the HO-ODU1 required between the nodes A and Bandwidth the traffics T5 and T6 are accommodated in the HO-ODU2 required between the nodes Bandwidth C. The traffics T3 and T4 are accommodated in the HO-ODUs1 and 2. Further, the traffics T7 and T8 are accommodated in the HO-ODU3 required between the nodes A and D. In the HO-ODUs1 to 3, all types of the bandwidths are ODU1 (TS×2) (see the description in parenthesis).

Herein, it is assumed that two TSs are insufficient and four TSs are demanded, in order for the HO-ODUs1 and 2 to accommodate the traffics T1 to T6 so as to satisfy Conditions (1) and (2). Such a case may include a case in which the numbers of TSs demanded for allocation are different according to application of Conditions (1) and (2), as described with reference to FIGS. 3 to 6.

As the result of the first design processing, since the bandwidth of the HO-ODU, that is, the number of TSs is insufficient, HO-ODUs4 and 5 are added in the second design processing, as illustrated in FIG. 28B. As a result, a housing destination of the traffic T2 is changed to the HO-ODU 4 and a housing destination of the traffic 6 is changed to the HO-ODU 5. A housing destination of the traffic T4 is changed to the HO-ODUs 4 and 5.

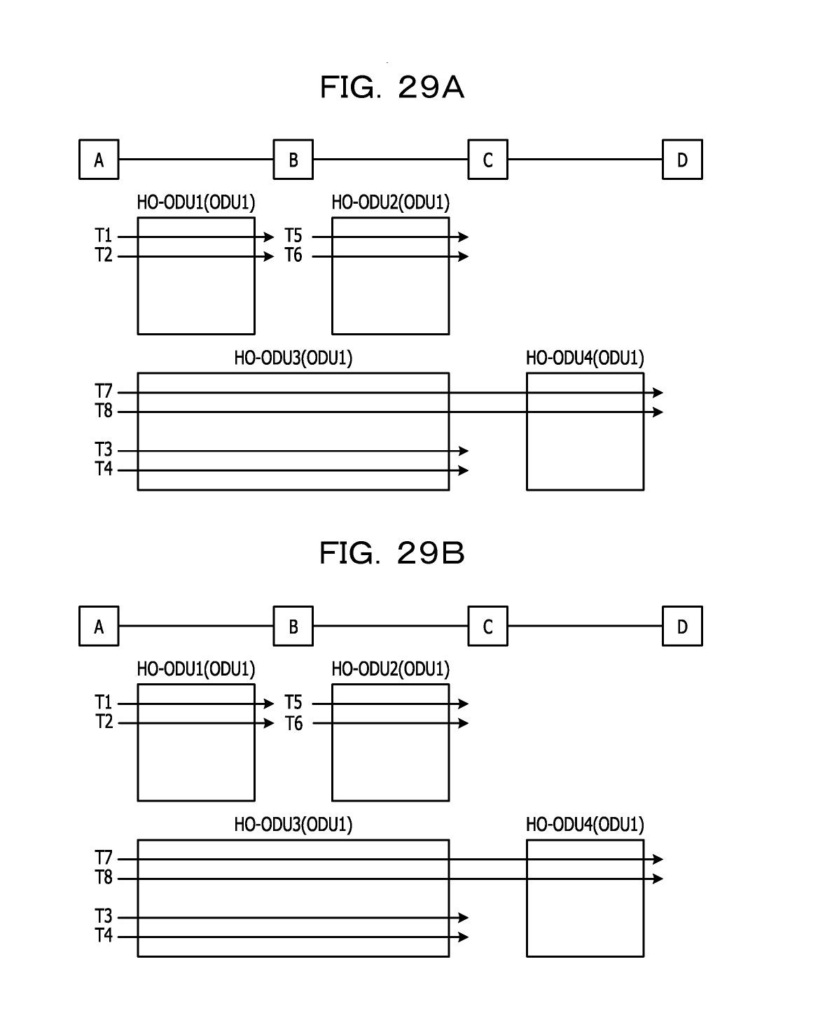

Meanwhile, FIG. 29 illustrates one example of the results of the first design processing and the second design processing in the embodiment. In more detail, FIG. 29A illustrates the result of the first design processing and FIG. 29B illustrates the result of the second design processing. As described above, in the embodiment, Conditions (1) and (2) are considered in both the first design processing and the second design processing. Further, in the example, the constitution of the network and the traffics T1 to T7 are common to the comparative example.

As illustrated in FIG. 29A, as the result of the first design processing, the traffics T1 and T2 are accommodated in the HO-ODU1 required between the nodes A and Bandwidth the traffics T5 and T6 are accommodated in the HO-ODU2 required between the nodes Bandwidth C. The traffics T3 and T4 are accommodated in the HO-ODU3 required between the nodes A and C. Further, the traffics T7 and T8 are accommodated in the HO-ODU3, and the HO-ODU4 required between the nodes C and D. In the HO-ODUs1 to 4, all types of the bandwidths are ODU1 (TS×2) (see the description in parenthesis).

The traffics T1 and T2 are accommodated in the HO-ODU1 different from the traffics T3 and T4, and the traffics T5 and T6 are also similar. That is, in the traffics T1 to T7, the bandwidth of TS×4 is allocated in its entirety. Accordingly, in the example, since the number of TSs demanded for allocation is sufficient unlike the comparative example, the HO-ODU is not added in the second design processing as illustrated in FIG. 29B.

As described above, in the embodiment, in the first design processing, since Conditions (1) and (2) are considered, the addition processing of the HO-ODU in the second design processing may be skipped and the design time may be shortened.

By the design method, since the precision of the estimation in the first design processing is improved, a network may be designed with a reduced cost. For example, the number of HO-ODUs is 5 in a design result of the comparative example, while the number of HO-ODUs is 4 in a design result of the embodiment. Therefore, when the network designing method according to the embodiment is used, a network may be designed at a lower cost than the comparative example.

Next, an application example of the network designing method described up to now will be described.

### Application Example 1

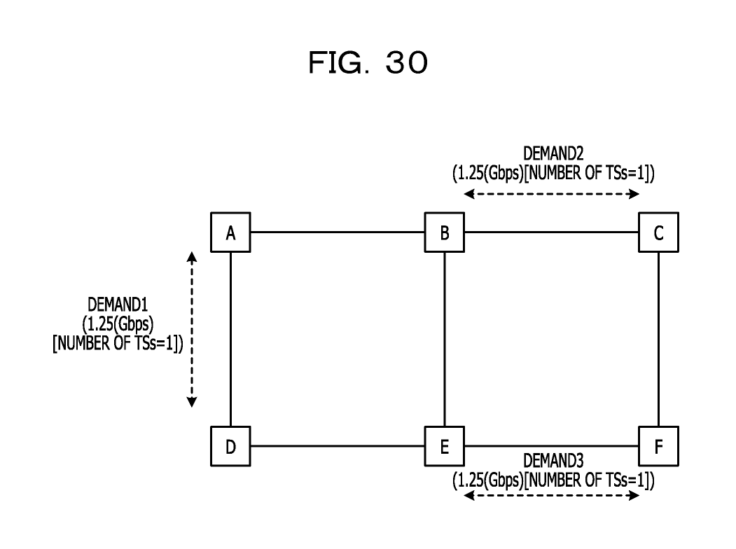

FIG. 30 illustrates an example of a demand imparted to a network. The demands 1 to 3 are imparted as the bandwidths of 1. 25 Gbps (the number of TSs=1) respectively used between the nodes A and D, between the nodes Bandwidth C, and between the nodes E and F. Further, for convenience, it is assumed that the path coincides with the link between the respective nodes. Further, it is assumed that the communication line used in each path is “ODU2” (2.5 Gbps) (the number of TSs=2).

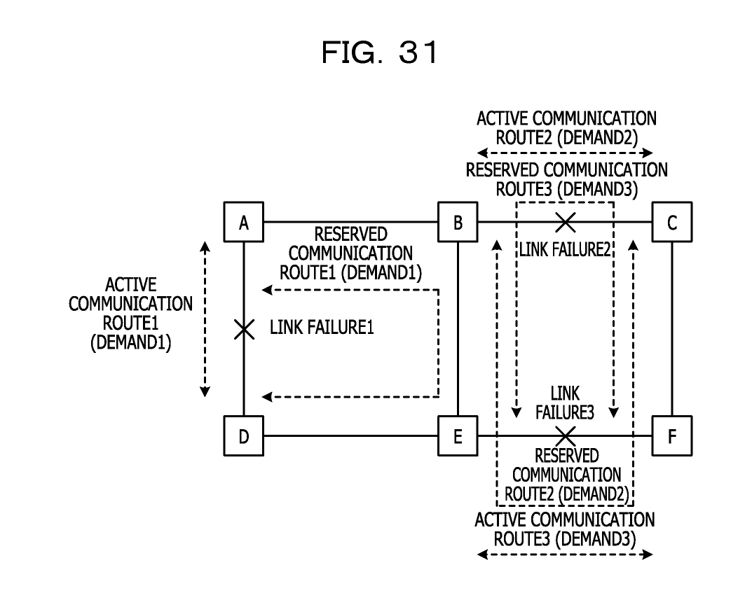

FIG. 31 illustrates the working and protecting communication routes of the network illustrated in FIG. 30. The first processing unit 100 determines working communication routes 1 to 3 and protecting communication routes 1 to 3 according to the respective demands 1 to 3. The working communication routes 1 to 3 are paths that connect between the nodes A and D, connect the nodes Bandwidth C, and connect the nodes E and F, respectively.

The first processing unit 100 permits sharing of the path among the protecting communication routes 1 to 3 to determine the protecting communication routes 1 to 3. The protecting communication route 1 is a path that connects the nodes A, B, E, and D and the protecting communication route 2 is a path that connects the nodes B, E, F, and C. Further, the protecting communication route 3 is a path that connects the nodes E, B, C, and F. Herein, the path between the nodes Bandwidth E is shared by the protecting communication routes 1 to 3.

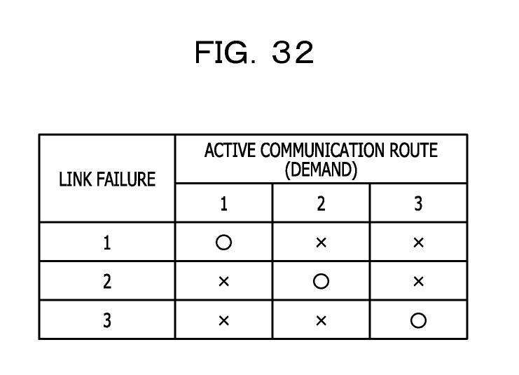

The first processing unit 100 estimates the bandwidths and the number of the HO-ODUs required in the respective paths by considering the bandwidths of the demands 1 to 3 and the sharing bandwidth among the protecting communication routes 1 to 3. FIG. 32 illustrates the working communication route in which the fault occurs by the link failures 1 to 3 illustrated in FIG. 31. In FIG. 32, the circle symbol (∘) represents that the fault occurs in the communication route by the link failure and the cross symbol (x) represents that the fault does not occur in the communication route by the link fault.

Since the paths of the working communication routes 1 to 3 are not overlapped with each other, the fault occurs in only the own communication route by the link failures 1 to 3 in each communication route. As a result, there is no case in which the protecting communication routes 1 to 3 are simultaneously used by switching the communication route when the fault occurs in the working communication routes 1 to 3. For example, when the link failure 1 occurs, since the fault occurs in the working communication route 1, the protecting communication route 1 is used and other protecting communication routes 2 and 3 are not used. As a result, the first processing unit 100 estimates a maximum value of the sharing bandwidth demanded by the link failures 1 to 3 as 1.25 Gbps (the number of TSs=1).

Accordingly, in estimation of the HO-ODU required in a path between the nodes Bandwidth E shared among the protecting communication routes 1 to 3, the number of HO-ODUs (“ODU2”) of 2.5 Gbps is one. Further, in regard to other paths, the number of HO-ODUs of 2.5 Gbps becomes one according to the bandwidths of the demands 1 to 3.

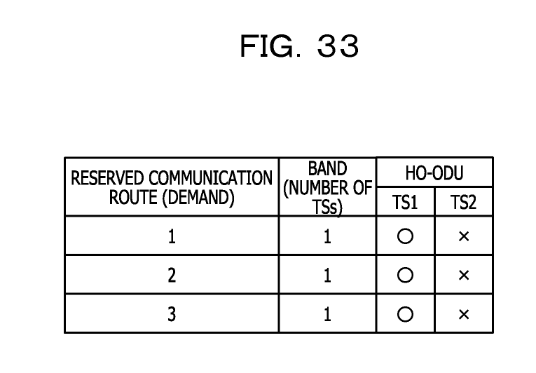

FIG. 33 illustrates an example of allocation of the TS to the protecting communication route illustrated in FIG. 31. In FIG. 33, the circle symbol (∘) represents that the TS is allocated and the cross symbol (x) represents that the TS is not allocated. Further, in the example, it is assumed that the maximum number Nₘₐₓ of Condition (1) is 3.

The second processing unit 101 allocates the TS1 of the HO-ODU to the protecting communication routes 1 to 3 based on the bandwidths (1.25 Gbps) of the demands 1 to 3 in regard to the path between the shared nodes Bandwidth E. That is, the TS1 is shared by the protecting communication routes 1 to 3. In this case, since the number of HO-ODUs estimated by the first processing unit 100 is sufficient and further, and Condition (1) is also satisfied (the sharing number of 3≦the maximum number Nₘₐₓ), the second processing unit 101 does not add the HO-ODU (see step St24 of FIG. 20). Further, Condition (2) is satisfied because the bandwidths of the demands 1 to 3 are the same as each other.

### Application example 2

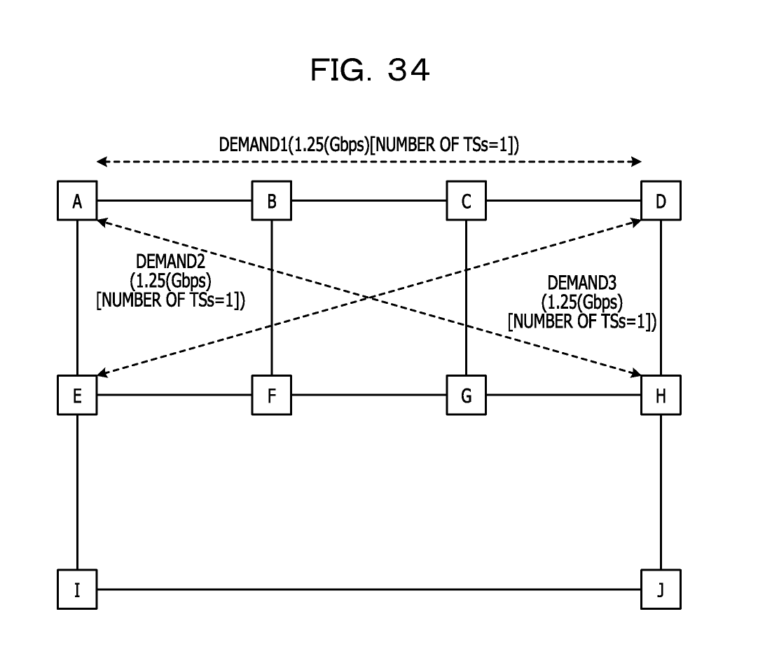

FIG. 34 illustrates another example of a demand imparted to a network. The demands 1 to 3 are imparted as the bandwidths of 1. 25 Gbps (the number of TSs=1) respectively used between the nodes A and D, between the nodes A and H, and between the nodes E and D. Further, for convenience, it is assumed that the path coincides with the link.

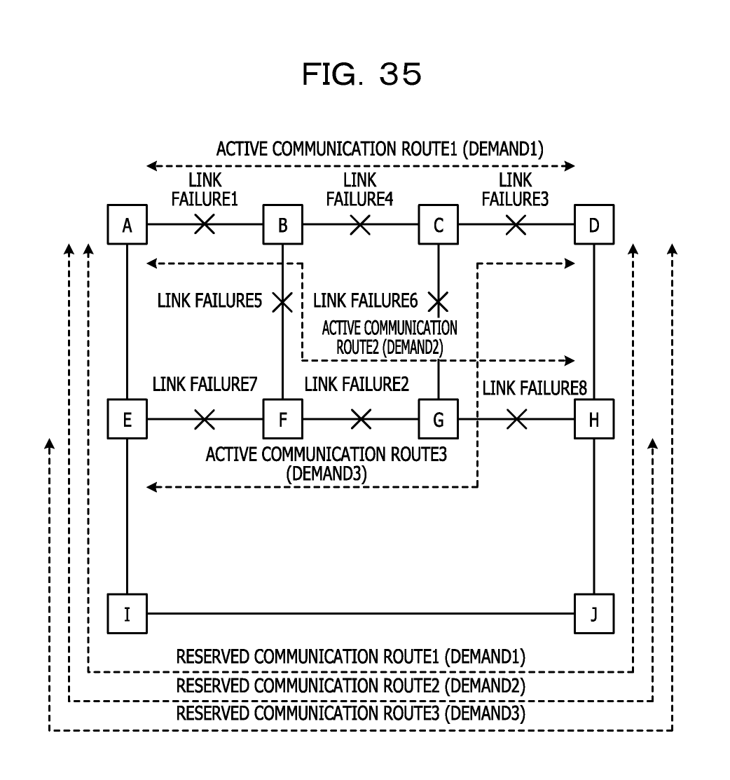

FIG. 35 illustrates the working and protecting communication routes of the network illustrated in FIG. 34. The first processing unit 100 determines working communication routes 1 to 3 and protecting communication routes 1 to 3 according to the respective demands 1 to 3. The working communication route 1 is a path that connects the nodes A, B, C, and D and the working communication route 2 is a path that connects the nodes A, B, F, G, and H. Further, the working communication route 3 is a path that connects the nodes E, F, G, C, and D.

The first processing unit 100 permits sharing of the path among the protecting communication routes 1 to 3 to determine the protecting communication routes 1 to 3. The protecting communication route 1 is a path that connects the nodes A, E, I, J, H, and D, and the protecting communication route 2 is a path that connects the nodes A, E, I, J, and H. Further, the protecting communication route 3 is a path that connects the nodes E, I, J, H, and D. Herein, the path between the nodes A and E is shared by the protecting communication routes 1 and 2. Further, each path among the nodes E, I, J, and H is shared by the protecting communication routes 1 to 3, and the path between the nodes H and D is shared by the protecting communication routes 1 and 3.

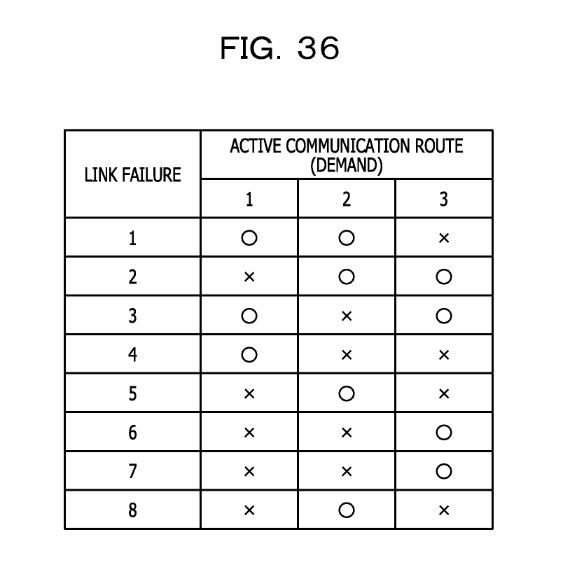

The first processing unit 100 estimates the bandwidths and the number of the HO-ODUs required in the respective paths by considering the bandwidths of the demands 1 to 3 and the sharing bandwidth among the protecting communication routes 1 to 3. FIG. 36 illustrates the working communication route in which the fault occurs by the link failures 1 to 8 illustrated in FIG. 35. In FIG. 36, the circle symbol (∘) represents that in which the fault occurs in the communication route by the link failure and the cross symbol (x) represents that in which the fault does not occur in the communication route by the link fault.

The paths of the working communication routes 1 and 2 are overlapped with each other in the link between the nodes A and B. The paths of the working communication routes 2 and 3 are overlapped with each other in the link between the nodes F and G. The paths of the working communication routes 1 and 3 are overlapped with each other in the link between the nodes C and D.

For this reason, the maximum number of communication routes in which the fault occurs by the link failures 1 to 8 in each communication route is 2. In other words, when the fault occurs in the working communication routes 1 to 3, among the protecting communication routes 1 to 3, two communication routes are simultaneously used.

As a result, the first processing unit 100 estimates a maximum value of the sharing bandwidth demanded by the link failures 1 to 8 as 2.5 Gbps (TS×2). Further, a total bandwidth of the demands 1 to 3 is TS×3, a bandwidth ratio becomes 1.5 (=3/2). Accordingly, when it is assumed that the maximum number Nₘₐₓ of Condition 1 is 2, a bandwidth ratio of 1.5 maximum number of 2 is satisfied. Further, Condition 2 is satisfied because the bandwidths of the demands 1 to 3 are the same as each other.

Accordingly, in estimation of the HO-ODU required in each path shared among the protecting communication routes 1 to 3, the number of HO-ODUs (“ODU2”) of 2.5 Gbps is one. Further, in regard to other paths, the number of HO-ODUs of 2.5 Gbps becomes one according to the bandwidths of the demands 1 to 3.

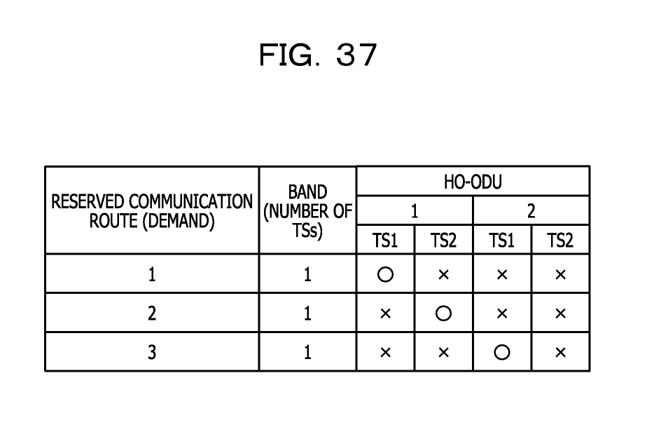

FIG. 37 illustrates an example of allocation of the TS to the protecting communication route (the path between the node I and J) illustrated in FIG. 35. The second processing unit 101 fixedly allocates the TS to the protecting communication routes 1 to 3. That is, the TS allocated to the protecting communication routes 1 to 3 is a specific TS and fixed.

According to the estimation of the first processing unit 100, when only one HO-ODU is used, for example, TS1 and TS2 of the HO-ODU1 are allocated to the protecting communication routes 1 and 2, respectively. In this case, the TS of one HO-ODU may not be fixedly allocated to the remaining protecting communication route 3 consequently because any one of the TS1 and TS2 of the HO-ODU1 needs to be dynamically allocated to the protecting communication route 3 according to the link failures 1 to 8. Accordingly, the second processing unit 101 determines that the number of HO-ODUs estimated by the first processing unit 100 is insufficient, and adds one HO-ODU (see step St24 of FIG. 20).

Accordingly, the second processing unit 101 individually allocates the TS1 and the TS2 of the two HO-ODUs1 and 2 to the protecting communication routes 1 to 3. As such, the second processing unit 101 may perform the fixed allocation of the TS which cannot be performed by the estimation of the HO-ODU unit considering the Conditions (1) and (2) by the first processing unit 100. That is, the second processing unit 101 provides a function of compensating for the allocation which cannot be performed by the first processing unit 100.

As described above, the network designing apparatus 1 according to the embodiment has the first processing unit 100 and the second processing unit 101. The first processing unit 100 selects one or more paths formed between the nodes in the network according to the demand of the bandwidth used in each communication between a plurality of sets of nodes in the network to determine a plurality of working communication routes and a plurality of protecting communication routes which connect the plurality of sets of nodes, respectively. Further, the first processing unit 100 estimates bandwidths and the number of HO-ODUs (communication lines) required on each of one or more selected paths. Meanwhile, the second processing unit 101 allocates the TSs of each of the HO-ODUs having the number of TSs according to the bandwidth of the HO-ODU to the plurality of working communication routes and the plurality of protecting communication routes, based on the demanded bandwidth.

The first processing unit 100 permits sharing one or more paths between the plurality of protecting communication routes to determine the plurality of protecting communication routes. In this case, the first processing unit 100 estimates the bandwidth of the communication line so that a ratio of a total bandwidth (bandwidth ratio) demanded for the plurality of communication routes sharing the path among the plurality of protecting communication routes, to a bandwidth shared among the plurality of communication routes is the maximum number (predetermined number) Nₘₐₓ or less.

The second processing unit 101 shares one or more paths among the plurality of protecting communication routes and allocates the common TS to the communication routes of the maximum number (predetermined number) Nₘₐₓ or less which are not simultaneously used, when the fault occurs in the plurality of working communication routes.

According to the network designing apparatus 1 according to the embodiment, since the common TS among the TSs of the HO-ODU is allocated to the protecting communication route, the SMR scheme may be implemented, and the network resource may be efficiently used. Further, according to the network designing apparatus 1 according to the embodiment, since the first processing unit 100 estimates the number of HO-ODUs and the second processing unit 101 performs the allocation of the TS, the design time may be efficiently shortened by a design processing divided into two steps.

The first processing unit 100 estimates the bandwidth of the HO-ODU so that the bandwidth ratio becomes the maximum number Nₘₐₓ or less. Herein, since the HO-ODU has the number of TSs according to the bandwidth, the bandwidth ratio represents an average value of the demand bandwidth accommodated in one TS included in the protecting sharing bandwidth, among the bandwidths of the HO-ODU.

Meanwhile, the second processing unit 101 allocates the common TS to the communication routes having the maximum number Nₘₐₓ or less that share one or more paths among the plurality of protecting communication routes. The maximum number Nₘₐₓ represents the maximum number of the protecting communication routes capable of sharing one TS. That is, the maximum number Nₘₐₓ represents the maximum of the average value of the demand bandwidths in which one TS may be received.

For this reason, the first processing unit 100 estimates the bandwidth of the HO-ODU so that the bandwidth ratio becomes the maximum number Nₘₐₓ or less to design the HO-ODU so as to satisfy Condition (1) prior to the processing of the second processing unit 101. Accordingly, the second processing unit 101 may perform the allocation of the TS within a short time. Further, by the network design satisfying Condition (1), the network with improved recovery performance for the fault is implemented.

A network designing apparatus 1 according to another embodiment has a first processing unit 100 and a second processing unit 101. The first processing unit 100 selects one or more paths formed between the nodes in the network according to the demand of the bandwidth used in each communication between a plurality of sets of nodes in the network to determine a plurality of working communication routes and a plurality of protecting communication routes which connect the plurality of sets of nodes. Further, the first processing unit 100 estimates bandwidths and the number of HO-ODUs (communication lines) required on each of one or more selected paths. Meanwhile, the second processing unit 101 allocates the TS of each of the HO-ODUs having the number of TSs according to the bandwidth of the HO-ODU to the plurality of working communication routes and the plurality of protecting communication routes, based on the demanded bandwidth.

The first processing unit 100 permits sharing one or more paths between the plurality of protecting communication routes to determine the plurality of protecting communication routes. In this case, the first processing unit 100 estimates a bandwidth shared between the communication routes sharing the path among the plurality of protecting communication routes, for each type of the demanded bandwidth.

The second processing unit 101 allocates the common TS to the communication routes which have the same type of demanded bandwidths, share one or more paths, and are not simultaneously used when the fault occurs in the plurality of working communication routes, among the plurality of protecting communication routes.

According to the network designing apparatus 1 according to the embodiment, since the common TS among the TSs of the HO-ODU is allocated to the protecting communication route, the SMR scheme may be implemented, and the network resource may be efficiently used. Further, according to the network designing apparatus 1 according to the embodiment, since the first processing unit 100 estimates the number of HO-ODUs and the second processing unit 101 performs the allocation of the TS, the design time may be efficiently shortened by a design processing divided into two steps.

The first processing unit 100 estimates the sharing bandwidth of the HO-ODU for each type of demanded bandwidths, and the second processing unit 101 allocates the common TS to the plurality of protecting communication routes having the same demanded bandwidth. For this reason, the first design processing unit 100 may estimate the sharing bandwidth of the HO-ODU for each type of the bandwidth of the demanded traffic to design the HO-ODU so as to satisfy Condition (2) prior to the second design processing. Accordingly, the second processing unit 101 may perform the allocation of the TS within a short time. Further, by the network design satisfying Condition (2), the network with improved recovery performance for the fault is implemented.

The network designing method according to the embodiment includes first design processing (step St1 of FIG. 9) performed by the first processing unit 100 and second design processing (step St2 of FIG. 9) performed by the second processing unit 101. In the first design processing, the first processing unit 100 selects one or more paths formed between the nodes in the network according to the demand of the bandwidth used in each communication between a plurality of sets of nodes in the network to determine a plurality of working communication routes and a plurality of protecting communication routes which connect the plurality of sets of nodes. Further, in the first design processing, the first processing unit 100 estimates bandwidths and the number of HO-ODUs (communication lines) required on each of one or more selected paths. Meanwhile, in the second design processing, the second processing unit 101 allocates the TSs of each of the HO-ODUs having the number of TSs according to the bandwidth of the HO-ODU to the plurality of working communication routes and the plurality of protecting communication routes, based on the demanded bandwidth.

In the first design processing, the first processing unit 100 permits the sharing of one or more paths between the plurality of protecting communication routes to determine the plurality of protecting communication routes. Further, the first processing unit 100 estimates the bandwidth of the communication line so that a ratio of a total bandwidth (bandwidth ratio) demanded for the plurality of communication routes sharing the path to a bandwidth shared between the plurality of communication routes is the maximum number (predetermined number) Nₘₐₓ or less, among the plurality of protecting communication routes.

In the second design processing, the common TS is allocated to the communication routes of the maximum number (predetermined number) Nₘₐₓ or less, which share one or paths and are not simultaneously used, when the fault occurs in the plurality of working communication routes, among the plurality of protecting communication routes.

Therefore, the network designing method according to the embodiment has the same configuration as the network designing apparatus 1 to show the same operational effect.

The network designing program according to the embodiment includes first design processing (step St1 of FIG. 9) performed by the first processing unit 100 and second design processing (step St2 of FIG. 9) performed by the second processing unit 101. In the first design processing, the first processing unit 100 selects one or more paths formed between the nodes in the network according to the demand of the bandwidth used in each communication between a plurality of sets of nodes in the network to determine a plurality of working communication routes and a plurality of protecting communication routes which connect the plurality of sets of nodes. Further, in the first design processing, the first processing unit 100 estimates bandwidths and the number of HO-ODUs (communication lines) required on each of one or more selected paths. Meanwhile, in the second design processing, the second processing unit 101 allocates the TSs of each of the HO-ODUs having the number of TSs according to the bandwidth of the HO-ODU to the plurality of working communication routes and the plurality of protecting communication routes, based on the demanded bandwidth.

In the first design processing, the first processing unit 100 permits the sharing of one or more paths between the plurality of protecting communication routes to determine the plurality of protecting communication routes. Further, the first processing unit 100 estimates the bandwidth of the communication line so that a ratio of a total bandwidth (bandwidth ratio) demanded for the plurality of communication routes sharing the path to a bandwidth shared between the plurality of communication routes is the maximum number (predetermined number) Nₘₐₓ or less, among the plurality of protecting communication routes.

In the second design processing, the common TS is allocated to the communication routes of the maximum number (predetermined number) Nₘₐₓ or less, which share one or more paths and are not simultaneously used, when the fault occurs in the plurality of working communication routes, among the plurality of protecting communication routes.

Therefore, the network designing program according to the embodiment has the same configuration as the network designing apparatus 1 to show the same operational effect.

In the embodiment described up to now, the first processing unit 100 and the second processing unit 101 have been assumed to have only the single link failure as the fault pattern, but the present disclosure is not limited thereto and design processing may be executed by proposing a plurality of link failures and a single or a plurality of node failures.

Hereinabove, although the content of the present disclosure has been described in detail with reference to the preferred embodiments, it is apparent to those skilled in the art that various modified aspects can be adopted based on the basic technical spirit and instruction of the present disclosure.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A network designing apparatus, comprising:
a first processing unit configured to select one or more paths formed among nodes in a network according to demands of bandwidths, each of which is used in communication among a plurality of sets of nodes in the network, determine a plurality of working communication routes and a plurality of protecting communication routes that connect the plurality of sets of nodes to each other, respectively and estimate bandwidths and the number of communication lines required in one or more selected paths, respectively; and
a second processing unit configured to allocate a predetermined number of logical channels to the plurality of working communication routes and the plurality of protecting communication routes based on the demanded bandwidths, the predetermined number of logical channels corresponding to a bandwidth that each of the communication lines has, and
wherein the first processing unit is configured to permit the one or more paths to be shared among the plurality of protecting communication routes to determine the plurality of protecting communication routes and estimate the bandwidths of the communication lines so that a ratio of a total bandwidth demanded for the plurality of communication routes sharing the path among the plurality of protecting communication routes to the bandwidth shared among the plurality of communication routes is equal to or less than a predetermined number, and
the second processing unit is configured to allocate the common logical channel to the number of communication routes of the predetermined number or less, which share the one or more paths and are not simultaneously used when a fault occurs in the plurality of working communication routes, among the plurality of protecting communication routes.

2. The network designing apparatus of claim 1, wherein the first processing unit is configured to estimate bandwidths shared among communication routes sharing the one or more paths among the plurality of protecting communication routes, for each of types of the demanded bandwidths, and
the second processing unit allocates the common logical channel to communication routes in which the types of the demanded bandwidths are the same as each other, among the plurality of protecting communication routes.

3. The network designing apparatus of claim 1, wherein the second processing unit is configured to add the communication line to a corresponding path among the one or more paths to execute allocation again when the logical channels allocated to the plurality of working communication routes or the plurality of protecting communication routes are insufficient.

4. The network designing apparatus of claim 1, wherein the first processing unit is configured to estimate the bandwidths and the number of the communication lines so that total cost of the communication lines in the network is minimum,
according to a first restriction condition in which each of the plurality of working communication routes and the plurality of protecting communication routes is one communication route selected from candidates of a plurality of communication routes acquired by selecting the one or more paths, respectively,
a second restriction condition in which a total bandwidth of communication lines is equal to or more than a sum of a total bandwidth of the communication routes including the path among the plurality of working communication routes and bandwidths shared among the plurality of protecting communication routes, in regard to each of one or more paths,
a third restriction condition in which the bandwidths shared among the plurality of protecting communication routes are equal to or more than a total bandwidth of a plurality of communication routes that share the path and are simultaneously used when a fault occurs in the plurality of working communication routes, among the plurality of protecting communication routes in regard to each of one or more paths, and
a fourth restriction condition in which a ratio of the total bandwidth of the communication routes including the path among the plurality of protecting communication routes to the bandwidth shared among the plurality of protecting communication routes is equal to or less than the predetermined number, in regard to each of the one or more paths.

5. The network designing apparatus of claim 1, wherein the second processing unit is configured to allocate the logical channels to each of the plurality of protecting communication routes sharing the one or more paths so that the number of the logical channels used in the network is minimum,
according to a fifth restriction condition in which the number of the logical channels allocated to each of the plurality of protecting communication routes is set to the number suitable for the demanded bandwidth,
a sixth restriction condition in which the number of the communication lines used in each of the plurality of protecting communication routes is set to one,
a seventh restriction condition in which the maximum number of the plurality of protecting communication routes using the logical channels, respectively is set to one when the fault occurs in the plurality of working communication routes, and
an eighth restriction condition in which the number of the plurality of protecting communication routes to which the logical channel is allocated is set to the predetermined number or less, in regard to each of the logical channels.

6. The network designing apparatus of claim 2, wherein the first processing unit is configured to estimate the bandwidths and the number of the communication lines so that total cost of the communication lines in the network is minimum,
according to a ninth restriction condition in which each of the plurality of working communication routes and the plurality of protecting communication routes is one communication route selected from candidates of a plurality of communication routes acquired by selecting the one or more paths, respectively,
a tenth restriction condition in which a total bandwidth of communication lines is equal to or more than a sum of a total bandwidth of the communication route including the path among the plurality of working communication routes and bandwidths shared among the plurality of protecting communication routes, in regard to each of the one or more paths,
an eleventh restriction condition in which the bandwidths shared among the plurality of protecting communication routes are equal to or more than a total bandwidth of a plurality of communication routes that share the path and are simultaneously used when a fault occurs in the plurality of working communication routes, among the plurality of protecting communication routes in regard to each of the one or more paths, for each type of demanded bandwidth, and
a twelfth restriction condition in which a ratio of the total bandwidth of the communication route including the path among the plurality of protecting communication routes to the bandwidth shared among the plurality of protecting communication routes is equal to or less than the predetermined number, in regard to each of the one or more paths, for each type of demanded bandwidth.

7. The network designing apparatus of claim 2, wherein the second processing unit is configured to allocate the logical channels to each of the plurality of protecting communication routes sharing the one or more paths so that the number of the logical channels used in the network is minimum,
according to a thirteenth restriction condition in which the number of the logical channels allocated to each of the plurality of protecting communication routes is set to the number suitable for the demanded bandwidth,
a fourteenth restriction condition in which the number of the communication lines used in each of the plurality of protecting communication routes is set to one,
a fifteenth restriction condition in which the maximum number of the plurality of protecting communication routes using the logical channels, respectively is set to one when the fault occurs in the plurality of working communication routes,
a sixteenth restriction condition in which the number of the plurality of protecting communication routes to which the logical channel is allocated is set to the predetermined number or less, in regard to each of the logical channels, and
an seventeenth restriction condition in which the number of the types of the demanded bandwidths is set to one for the plurality of protecting communication routes to which the logical channel is allocated, in regard to each of the logical channels.

8. A network designing method, comprising:
selecting one or more paths formed among nodes in a network according to demands of bandwidths, each of which is used in communication among a plurality of sets of nodes in the network, to determine a plurality of working communication routes and a plurality of protecting communication routes that connect the plurality of sets of nodes to each other, respectively, and estimating bandwidths and the number of communication lines required in each of the one or more selected paths; and
allocating a predetermined number of logical channels to the plurality of working communication routes and the plurality of protecting communication routes based on the demanded bandwidths, the predetermined number of logical channels corresponding to a number of logical channels that each of the communication lines has,
wherein in the estimating of the bandwidths and the number of the communication lines, the one or more paths are permitted to be shared among the plurality of protecting communication routes to determine the plurality of protecting communication routes and estimate the bandwidths of the communication lines so that a ratio of a total bandwidth demanded for the plurality of communication routes sharing the path among the plurality of protecting communication routes to the bandwidth shared among the plurality of communication routes is equal to or less than a predetermined number, and
in the allocating of the logical channels, the common logical channel is allocated to the number of communication routes having the predetermined number or less, which share the one or more paths and are not simultaneously used when a fault occurs in the plurality of working communication routes, among the plurality of protecting communication routes.

9. The network designing method of claim 8, wherein in the estimating of the bandwidths and the number of the communication lines, bandwidths shared among communication routes sharing the one or more paths among the plurality of protecting communication routes are estimated for each type of the demanded bandwidth, and
in the allocating of the logical channels, the common logical channel is allocated to communication routes in which the types of the demanded bandwidths are the same as each other, among the plurality of protecting communication routes.

10. The network designing method of claim 8, wherein in the allocating of the logical channels, the communication line is added to a corresponding path among the one or more paths to execute allocation again when the logical channels allocated to the plurality of working communication routes or the plurality of protecting communication routes are insufficient.

11. A computer-readable recording medium storing a network designing program, when executed, causes a computer to perform a network designing method comprising:
selecting one or more paths formed among nodes in a network according to demands of bandwidths, each of which is used in communication among a plurality of sets of nodes in the network, to determine a plurality of working communication routes and a plurality of protecting communication routes that connect the plurality of sets of nodes to each other, respectively and estimating bandwidths and the number of communication lines required in each of the one or more selected paths; and
allocating a predetermined number of logical channels to the plurality of working communication routes and the plurality of protecting communication routes based on the demanded bandwidths, the predetermined number of logical channels corresponding to a number of logical channels that each of the communication lines has,
wherein in the estimating of the bandwidths and the number of the communication lines, the one or more paths are permitted to be shared among the plurality of protecting communication routes to determine the plurality of protecting communication routes and estimate the bandwidths of the communication lines so that a ratio of a total bandwidth demanded for the plurality of communication routes sharing the path among the plurality of protecting communication routes to the bandwidth shared among the plurality of communication routes is equal to or less than a predetermined number, and
in the allocating of the logical channels, the common logical channel is allocated to the number of communication routes having the predetermined number or less, which share the one or more paths and are not simultaneously used when a fault occurs in the plurality of working communication routes, among the plurality of protecting communication routes.

12. The computer-readable storage medium according to claim 11, wherein the network designing program, when executed by a computer, further causes the computer to perform:
in the estimating of the bandwidths and the number of the communication lines, causing bandwidths shared among communication routes sharing the one or more paths among the plurality of protecting communication routes to be estimated for each type of the demanded bandwidth, and
in the allocating of the logical channels, causing the common logical channel is allocated to communication routes in which the types of the demanded bandwidths to be the same as each other, among the plurality of protecting communication routes.

13. The computer-readable storage medium according to claim 11, wherein the network designing program, when executed by a computer, further causes the computer to perform:
in the allocating of the logical channels, causing the communication line to be added to a corresponding path among the one or more paths to execute allocation again when the logical channels allocated to the plurality of working communication routes or the plurality of protecting communication routes are sufficient.
